(19) United States
(12) Patent Application Publication
(10) Pub. No.: US 2018/0314199 A1
(43) Pub. Date: Nov. 1, 2018

(54) IMAGE FORMING DEVICE AND IMAGE FORMING METHOD

(71) Applicant: SHARP KABUSHIKI KAISHA, Sakai City (JP)

(72) Inventors: KYOHKO MATSUDA, Sakai City (JP); YUSUKE SAKAKIBARA, Sakai City (JP); MAKOTO IZUMI, Sakai City (JP)

(21) Appl. No.: 15/935,577

(22) Filed: Mar. 26, 2018

(30) Foreign Application Priority Data
Apr. 28, 2017 (JP) 2017-090479

(51) Int. Cl. G03G 15/00

(52) U.S. Cl. CPC G03G 15/5029; G03G 2215/00616; G03G 15/6558; G03G 15/6511

(57) ABSTRACT

A copier is provided with a first illuminator that irradiates a light to a sheet of paper; a second photodetector that receives a portion of a light transmitted through the sheet of paper; a first photodetector that receives a portion of a light reflected or diffused by the sheet of paper; a paper-type determination processor, a moisture-content calculator, and a basis-weight calculator that calculate or determine at least one from among a moisture content, a type, and a basis weight of the sheet of paper; and an image forming conditions configuration processor that configures image forming conditions for the sheet of paper.

### CROSS-REFERENCE TO RELATED APPLICATIONS

This application claims the benefit of priority to Japanese Patent Application Number 2017-090479 filed on Apr. 28, 2017. The entire contents of the above-identified application are hereby incorporated by reference.

### BACKGROUND

### Technical Field

The following disclosure relates to an image forming device that forms an image on a sheet of paper and an image forming method of the image forming device.

In an image forming device such as a copier, a printer, a fax machine, or a multifunction peripheral combining these, image formation (printing) is performed in a process such as follows. First, after adhering toner by static electricity on a photoreceptor drum, a potential difference with a sheet of paper is created to transfer the toner to the sheet of paper. Next, heating and pressurizing are performed by a heating roller and a pressure roller and the toner is fixed to the sheet of paper.

However, in a situation where a sheet of paper that is thicker than anticipated is used, a pressurizing pressure of the pressure roller or a conveyance speed of the sheet of paper becomes inappropriate and an image quality of an image to be printed decreases. Moreover, in a situation where a moisture content of the sheet of paper is high, a potential difference necessary when transferring is not created, generating color unevenness where color differs according to a location on the sheet of paper or with each sheet of paper and decreasing the image quality of the image to be printed.

To solve the problems above, a technique of controlling image forming conditions (printing conditions) according to a state of a sheet of paper P is disclosed in JP 2013-57513 A.

The technique disclosed in JP 2013-57513 A irradiates a light to the sheet of paper, which is a target of printing; receives the light, which is reflected or scattered by the sheet of paper; and calculates a moisture content of the sheet of paper based on an intensity of the received light. Then, based on the calculated moisture content, the image forming conditions are configured.

### SUMMARY

However, with the technique disclosed in JP 2013-57513 A, because the moisture content is calculated using only the light reflected or scattered by the sheet of paper, a calculation precision of the moisture content is low and there is a problem where the image forming conditions may not be able to be configured appropriately.

One aspect of the disclosure has as an object to realize an image forming device and an image forming method whereby appropriate image forming conditions can be configured.

To solve the problem above, an image forming device according to one aspect of the disclosure is an image forming device that forms an image on a recording material, provided with: a first illuminator and a second illuminator that irradiate a light to the recording material; a transmitted-light photodetector that receives a portion of a light that is irradiated from the first illuminator and transmitted through the recording material; a reflected-light photodetector that receives a portion of a light that is irradiated from the second illuminator and reflected or scattered by the recording material; a calculator that calculates or determines at least one from among a moisture content, a type, and a basis weight of the recording material based on intensities of the lights received by the transmitted-light photodetector and the reflected-light photodetector; and a configuration processor that configures image forming conditions of the image on the recording material based on a calculation or determination result of the calculator.

To solve the problem above, an image forming method according to one aspect of the disclosure is an image forming method of forming an image on a recording material, provided with: a first measurement step of measuring an intensity of a light that is irradiated from a first illuminator and transmitted through the recording material; a second measurement step of measuring an intensity of a light that is irradiated from a second illuminator and reflected or scattered by the recording material; a calculation step of calculating or determining at least one from among a moisture content, a type, and a basis weight of the recording material based on the intensities of the lights measured at the first measurement step and the second measurement step; and a configuration step of configuring image forming conditions of the image on the recording material based on a calculation or determination result at the calculation step.

According to one aspect of the disclosure, an effect is exhibited where appropriate image forming conditions can be configured.

### BRIEF DESCRIPTION OF DRAWINGS

The disclosure will be described with reference to the accompanying drawings, wherein like numbers reference like elements.

FIG. 1 is a schematic view illustrating a structure of a copier according to Embodiment 1 of the disclosure.

FIG. 2 is a block diagram illustrating a configuration of a main portion of the copier above.

FIG. 3 is a schematic view illustrating a configuration of an optical sensor provided by the copier above.

FIG. 4 is a flowchart illustrating one example of a flow of processing of performing double-sided printing on a sheet of paper using the copier above.

FIG. 5 is a flowchart illustrating one example of a flow of printing processing in the copier above.

FIG. 6 is a table indicating a correspondence relationship between a paper-type degree of the sheet of paper and a paper type of the sheet of paper.

FIG. 7 is a graph used in a situation of determining the paper type of the sheet of paper using two indicators.

FIG. 8 is a top view of the sheet of paper illustrating irradiation locations of a light to the sheet of paper by the optical sensor above.

FIG. 9 is a flowchart illustrating one example of a flow of processing of determining the paper type of the sheet of paper by the paper-type determination processor of the copier as a modified example of the copier in Embodiment 1.

FIG. 10 is a block diagram illustrating a configuration of a main portion of a copier as another modified example of the copier in Embodiment 1.

FIG. 11 is a schematic view illustrating a configuration of the optical sensor provided by the copier above.

FIG. 12 is a flowchart illustrating one example of a flow of printing processing in the copier above.

FIG. 13 is a block diagram illustrating a configuration of a main portion of a copier according to Embodiment 2 of the disclosure.

FIG. 14 is a schematic view illustrating a configuration of an optical sensor provided by the copier above.

FIG. 15 is a flowchart illustrating one example of a flow of printing processing in the copier above.

FIG. 16 is a block diagram illustrating a configuration of a main portion of a copier according to Embodiment 3 of the disclosure.

FIG. 17 is a schematic view illustrating a configuration of an optical sensor provided by the copier above.

FIG. 18 is a flowchart illustrating one example of a flow of printing processing in the copier above.

FIG. 19 is block diagram illustrating a configuration of a main portion of a copier according to Embodiment 4 of the disclosure.

FIG. 20 is a schematic view illustrating a configuration of an optical sensor provided by the copier above.

FIG. 21 is a flowchart illustrating one example of a flow of printing processing in the copier above.

FIG. 22 is a block diagram illustrating a configuration of a main portion of a copier according to Embodiment 5 of the disclosure.

FIG. 23 is a schematic view illustrating a configuration of an optical sensor provided by the copier above.

FIG. 24 is a flowchart illustrating one example of a flow of printing processing in the copier above.

FIG. 25 is a block diagram illustrating a configuration of a main portion of a copier according to Embodiment 6 of the disclosure.

FIG. 26 is a schematic view illustrating a configuration of an optical sensor provided by the copier above.

FIG. 27 is a flowchart illustrating one example of a flow of printing processing in the copier above.

FIG. 28 is a block diagram illustrating a configuration of a main portion of a copier according to Embodiment 7 of the disclosure.

FIG. 29 is a schematic view illustrating a configuration of an optical sensor provided by the copier above.

FIG. 30 is a flowchart illustrating one example of a flow of printing processing in the copier above.

FIG. 31 is a schematic view illustrating a structure of a copier according to Embodiment 8 of the disclosure.

FIG. 32 is a flowchart illustrating one example of a flow of printing processing in the copier above.

### DESCRIPTION OF EMBODIMENTS

### Embodiment 1

A copier 1A as an image forming device of Embodiment 1 of the disclosure and an image forming method of the copier 1A are described in detail below with reference to the drawings. The copier 1A prints (performs image formation for) image data on a sheet of paper (recording material) P.

### Structure of Copier 1A

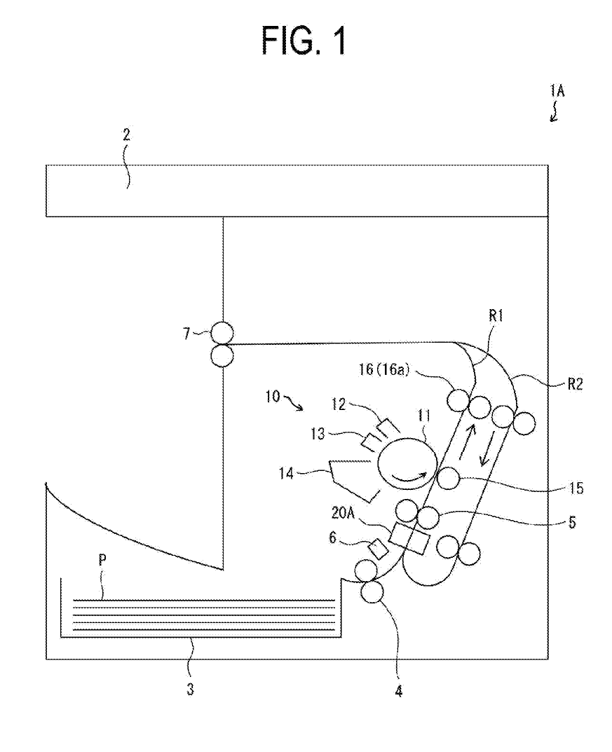

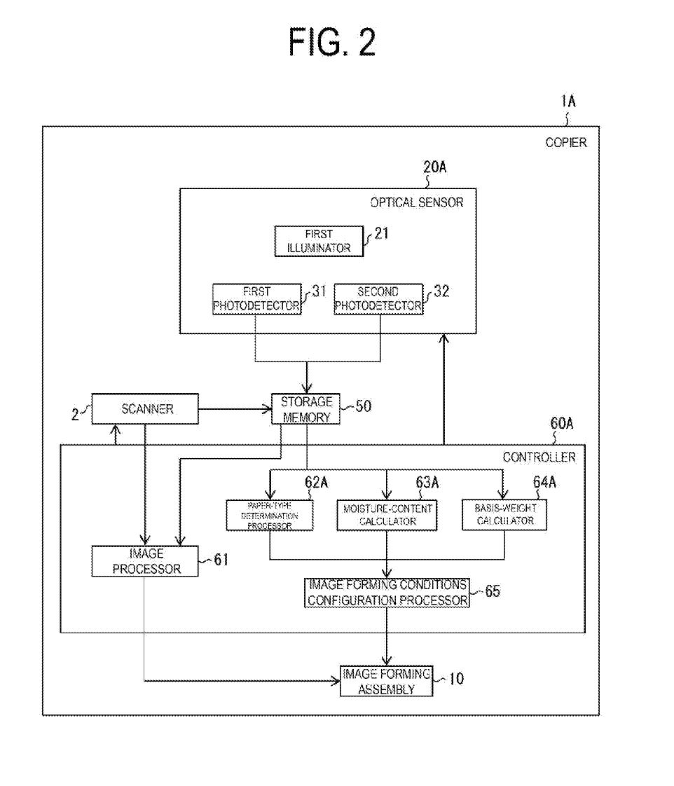

A configuration of the copier 1A is described with reference to FIG. 1 and FIG. 2. FIG. 1 is a schematic view illustrating a structure of the copier 1A. FIG. 2 is a block diagram illustrating a configuration of a main portion of the copier 1A.

As illustrated in FIG. 1 and FIG. 2, the copier 1A is provided with a scanner 2, a paper feed cassette 3, a pickup roller (extraction roller) 4, a pre-resist sensor 6, an idle roller (retention roller) 5, an image forming assembly 10, an optical sensor 20A, an output roller 7, a storage memory 50, and a controller 60A.

The scanner 2 is for reading image data (original data) of an original placed in an original tray (not illustrated). The scanner 2 sends read image data to the storage memory 50 or an image processor 61, which are described below.

The paper feed cassette 3 is a container containing the sheet of paper P whereon printing is performed by the copier 1A.

The pickup roller 4 is a roller for feeding the sheet of paper P contained in the paper feed cassette 3 to a main conveyance route R1. Note that the main conveyance route R1 is a conveyance route that starts at the paper feed cassette 3; passes through the image forming assembly 10, which is described below; and ends at the output roller 7.

The pre-resist sensor 6 is a switch disposed between the pickup roller 4 and the idle roller 5, which is described below, in the main conveyance route R1. The pre-resist sensor 6 sends a sensing signal to the idle roller 5 when the pre-resist sensor 6 senses that the sheet of paper P fed by the pickup roller 4 passes by. In the copier 1A in the present embodiment, the pre-resist sensor 6 is disposed between the pickup roller 4 and the idle roller 5 but is not limited thereto; it is sufficient for a position wherein the pre-resist sensor 6 is disposed to be a position where it can be sensed that the sheet of paper P fed by the pickup roller 4 passes by to send the sensing signal to the idle roller 5.

The idle roller 5 is disposed between the pickup roller 4 and the image forming assembly 10, which is described below, in the main conveyance route R1 and is a roller for temporarily retaining the sheet of paper P. When the idle roller 5 receives the sensing signal of the passage of the sheet of paper P from the pre-resist sensor 6, the idle roller 5 temporarily retains the sheet of paper P and releases retention of the sheet of paper P at a predetermined timing.

The image forming assembly 10 prints an image indicated by the image data of the original read by the scanner 2 on the sheet of paper P. The image forming assembly 10 is provided with a photoreceptor drum (image-carrying body) 11, a charger 12, a laser scanner 13, a developing device 14, a transfer device (transfer device) 15, a fuser 16, and a cleaning device (not illustrated).

Here, basic operations of printing on the sheet of paper P by the image forming assembly 10 are described. Note that detailed printing operations in the copier 1A are described below.

In printing by the image forming assembly 10, first, the charger 12 uniformly charges the photoreceptor drum 11 by a predetermined voltage. Note that the photoreceptor drum 11 has a drum shape and rotates in the direction of the arrow illustrated inside the photoreceptor drum 11 in FIG. 1.

Next, the laser scanner 13 exposes a laser light to the photoreceptor drum 11. By this, an electrostatic latent image based on the image data, which is applied with image processing, is formed on a surface of the photoreceptor drum 11.

Next, the developing device 14 adheres a toner agent (developing agent) stored inside the developing device 14 to the surface of the photoreceptor drum 11 and develops a toner image (developed image) based on the electrostatic latent image above on the surface of the photoreceptor drum 11. Specifically, the developing device 14 is provided with a developing roller (not illustrated) and a developing bias is applied to this developing roller. Then, by a potential difference arising according to the developing bias applied to the developing roller and a charged state of the surface of the photoreceptor drum 11, the toner agent adheres to the surface of the photoreceptor drum 11. By this, the toner image based on the electrostatic latent image is developed on the surface of the photoreceptor drum 11.

Next, the transfer device 15 performs transfer processing of transferring the toner image developed on the surface of the photoreceptor drum 11 to the sheet of paper P. Specifically, the toner image developed on the surface of the photoreceptor drum 11 is transferred to the sheet of paper P by applying a transfer potential to the transfer device 15 and supplying a transfer current. The transfer potential applied to the transfer device 15 and the current supplied to the transfer device 15 are configured by an image forming conditions configuration processor 65, which is described below.

Next, the fuser 16 fixes (fixes) the toner image transferred to the sheet of paper P to the sheet of paper P. Specifically, the fuser 16 is provided with a pressure roller 16a and a halogen lamp (not illustrated) as a heat source, heats the sheet of paper P whereto the toner image is transferred by the halogen lamp, and pressurizes the sheet of paper P at a predetermined pressure by the pressure roller 16a. By this, the toner image transferred to the sheet of paper P melts and is fixed (fixed) to the sheet of paper P. The pressure whereat the pressure roller 16a pressurizes the sheet of paper P, a current that drives the heat source (halogen lamp), and a conveyance speed of the sheet of paper P when fixing are configured by the image forming conditions configuration processor 65, which is described below.

As above, in the image forming assembly 10, the image indicated by the image data is printed on the sheet of paper P by performing the transfer processing of the photoreceptor drum 11 carrying the toner image obtained by developing the electrostatic latent image based on the image data by the toner agent and the transfer device 15 transferring the toner image to the sheet of paper P.

Furthermore, by the cleaning device removing toner agent remaining on the surface of the photoreceptor drum 11 after transferring and the charger 12 uniformly charging the photoreceptor drum 11 by the predetermined voltage, the photoreceptor drum 11 is placed in a state of being able to perform the next printing processing.

The output roller 7 is a roller for outputting the printed sheet of paper P to an output tray (not illustrated). The output roller 7 can rotate in both a direction of outputting the sheet of paper P to the outside and a reverse direction thereof.

Furthermore, the copier 1A is provided with a secondary conveyance route R2. The secondary conveyance route R2 is a conveyance route used when printing the sheet of paper P a plurality of times (for example, on both faces). The secondary conveyance route R2 branches off from the main conveyance route R1 between the fuser 16 and the output roller 7 and is a conveyance route connecting this branching point to a point between the pickup roller 4 and the optical sensor 20A in the main conveyance route R1.

The branching point above is provided with a branching claw, and the branching claw can be operated to two sides. When the branching claw is operated to one side (main-conveyance-route R1 side), the sheet of paper P that passes by the fuser 16 is conveyed to the output roller 7. Meanwhile, by operating the branching claw to the other side (secondary-conveyance-route R2 side) and rotating the output roller 7 in the opposite direction of the direction wherein the sheet of paper P is output, the sheet of paper P conveyed to the output roller 7 is conveyed in a reverse direction of a travel direction in the main conveyance route R1 (that is, switchback conveyed) and conveyed from the branching point to the secondary conveyance route R2. The sheet of paper P conveyed to the secondary conveyance route R2 is conveyed to between the pickup roller 4 and the optical sensor 20A in the main conveyance route R2 via the secondary conveyance route R2. At this time, the sheet of paper P is in a state where front and back are reversed and up and down are reversed from when the sheet of paper P passes through the image forming assembly 10 immediately before. By this, printing the sheet of paper P the plurality of times is enabled.

### Optical Sensor 20A

The optical sensor 20A irradiates a light to one sheet of paper P retained by the idle roller 5 and measures an intensity of the light transmitted through the sheet of paper P and an intensity of the light reflected or diffused (scattered) by the sheet of paper P. The intensities of the lights measured by the optical sensor 20A are output to the controller 60A, which is described below, and used for determination of a paper type of the sheet of paper P, calculation of a moisture content of a surface of the sheet of paper P, and calculation of a basis weight (weight of paper per unit area) of the sheet of paper P in the controller 60A. Note that “paper type” in the present specification is defined as types of paper where characteristics of paper such as a thickness of the paper, a basis weight of the paper, and a smoothness of a paper surface are different and types of paper having different properties, such as paper including different components, such as normal paper and premium paper.

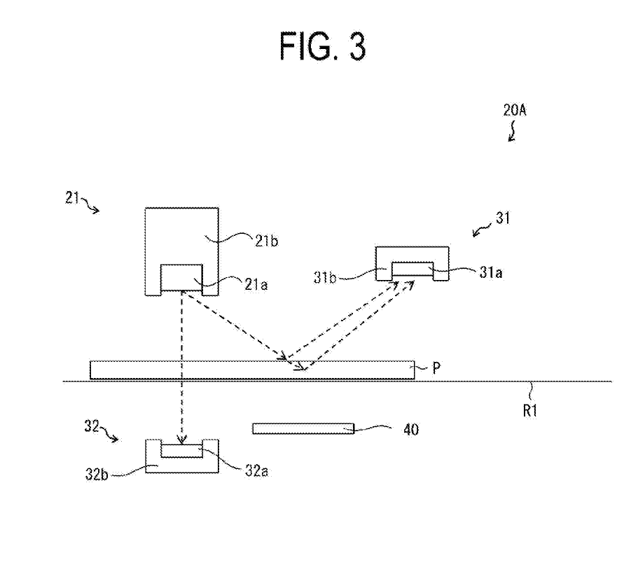

FIG. 3 is a schematic view illustrating a configuration of the optical sensor 20A. As illustrated in FIG. 2 and FIG. 3, the optical sensor 20A is provided with a first illuminator (first illuminator, second illuminator) 21, a first photodetector (reflected-light photodetector) 31, a second photodetector (transmitted-light photodetector), and a standard reflector 40.

The first illuminator 21 is provided with one light source 21a and a housing 21b that houses the light source 21a.

The light source 21a includes a semiconductor light-emitting element (LED: light-emitting diode). A wavelength of a light irradiated (emitted) by the light source 21a is not limited in particular but is preferably from 800 nm to 1100 nm. A situation where the wavelength of the light irradiated by the light source 21a is greater than 1100 nm is not preferable because an expensive semiconductor light-emitting element needs to be used. Moreover, a situation where the wavelength of the light irradiated by the light source 21a is less than 800 nm is not preferable because (1) absorption of the light by moisture included in the sheet of paper P decreases and (2) due to the light being in a visible-light region, in a situation where the sheet of paper P is a colored sheet of paper, transmission and reflection of the light are affected by the color of the sheet of paper P, decreasing precision in determining the paper type of the sheet of paper P, which is described below. Note that the wavelength and an intensity of the light irradiated by the first illuminator 21 (light source 21a) are selected as appropriate according to the configuration of the copier 1A, the paper type of the sheet of paper P to be measured, and the like.

As illustrated in FIG. 3, the light source 21a is disposed inside the housing 21b, inward of an outer surface of the housing 21b. By this, the light irradiated from the first illuminator 21 (light source 21a) being directly received by the first photodetector 31 can be prevented.

Note that the present embodiment is of a configuration where the LED is provided as the light source 21a of the first illuminator 21 but is not limited thereto. It is sufficient for a light source of an illuminator of one aspect of the disclosure to be a light source that can irradiate a light of a wavelength whereby determination of the sheet of paper P and calculation of the moisture content and the basis weight are possible, and a configuration may be such that provided is, for example, a halogen lamp or a fluorescent body. In a situation of a light source where a wavelength of an emitted light has a certain range, such as a halogen lamp or a fluorescent body, this light includes a plurality of wavelengths. Therefore, even in a situation of the configuration of providing a halogen lamp or a fluorescent body as the light source, it is preferable for the light source to be provided with a wavelength filter that allows a light of a predetermined wavelength to pass through and for the illuminator to irradiate a light of a wavelength with a small full width at half maximum.

As illustrated in FIG. 3, the first photodetector 31 is provided with one light receiving device 31a and a housing 31b that houses the light receiving device 31a. The first photodetector 31 is provided on the same side as the first illuminator 21 in relation to the main conveyance route R1.

The light receiving device 31a is a photodiode. The first photodetector 31 amplifies by an amplification circuit (not illustrated) an electrical signal value of a size in accordance with an intensity of a light received at the light receiving device 31a, afterward converts this into a digital signal by an AD (analog-digital) converter (not illustrated), and outputs this to the storage memory 50. The light receiving device 31a is selected to sense a light in a wavelength range including the wavelength of the light irradiated by the light source 21a of the first illuminator 21.

As illustrated in FIG. 3, the light receiving device 31a is disposed inside the housing 31b, inward of an outer surface of the housing 31b. By this, the light irradiated from the first illuminator 21 (light source 21a) being directly received by the first photodetector 31 can be prevented.

Note that while the light receiving device 31a in the present embodiment is the photodiode, the copier of the disclosure is not limited thereto. That is, the light receiving device of the first photodetector 31 in the copier of the disclosure may be a phototransistor, an avalanche photodiode, or a photomultiplier. However, the light receiving device of the first photodetector 31 is preferably the photodiode because a photodiode is inexpensive and does not take up space.

As illustrated in FIG. 3, the second photodetector 32 is provided on an opposite side of the first illuminator 21 in relation to the main conveyance route R1. The second photodetector 32 is provided with one light receiving device 32a and a housing 32b that houses the light receiving device 32a. Because a configuration of the second photodetector 32 is similar to the configuration of the first photodetector 31, description thereof is omitted. The second photodetector 32 amplifies by an amplification circuit (not illustrated) an electrical signal value of a size in accordance with an intensity of a light received at the light receiving device, afterward converts this into a digital signal by an AD (analog-digital) converter (not illustrated), and outputs this to the storage memory 50.

The second photodetector 32 in the present embodiment receives a light that is irradiated perpendicular to the surface of the sheet of paper P from the first illuminator 21 and transmitted through the sheet of paper P. However, the second photodetector 32 according to one aspect of the disclosure may be of an aspect of receiving a light that is irradiated at an angle not perpendicular to the surface of the sheet of paper P from the first illuminator 21 and transmitted through the sheet of paper P.

The standard reflector 40 is a reflector for reflecting the light irradiated from the first illuminator 21 to the first photodetector 31 in a state where there is no sheet of paper P between the first illuminator 21 and the standard reflector 40. In the copier 1A in the present embodiment, the standard reflector 40 is provided on the opposite side of the first illuminator 21 in relation to the main conveyance route R1. However, in the copier of the disclosure, a location where the first illuminator 21 is provided is not limited thereto. It is sufficient for the location where the first illuminator 21 is provided to be a location where a light that is irradiated from the first illuminator 21 and reflected by the standard reflector 40 is directly received by the first photodetector 31 without being blocked. The standard reflector 40 is a member with high reflectance and in the present embodiment is polytetrafluoroethylene (PTFE). An intensity of a light that is irradiated from the first illuminator 21, reflected by a surface of the standard reflector 40, and received by the first photodetector 31 is used as reference data in determining the paper type of the sheet of paper P, calculating the moisture content of the surface of the sheet of paper P, and calculating the basis weight of the sheet of paper P, which are described below.

The storage memory 50 stores information necessary for printing by the copier 1A. For example, the storage memory 50 is provided with a region for temporarily storing the image data read by the scanner 2; a region for storing various programs executed by each section of the controller 60A, which is described below, and data used in these programs; and the like. Moreover, the storage memory 50 is provided with a region for storing internal control data of the copier 1A for, for example, voltages and currents applied and supplied to each element of the image forming assembly 10, the control data being changed according to conditions configured by a user, and various equations used to determine the paper type of the sheet of paper P, calculate the moisture content of the surface of the sheet of paper P, and calculate the basis weight of the sheet of paper P.

The controller 60A controls operations of each section of the copier 1A. Moreover, as illustrated in FIG. 2, the controller 60A is provided with the image processor 61, a paper-type determination processor (calculator) 62A, a moisture-content calculator (calculator) 63A, a basis-weight calculator (calculator) 64A, and the image forming conditions configuration processor (configuration processor) 65.

The image processor 61 applies image processing on the image data read by the scanner 2 or the image data read by the scanner 2 and stored in the storage memory 50. The image processor 61 outputs the image data applied with image processing to the image forming assembly 10.

The paper-type determination processor 62A, the moisture-content calculator 63A, and the basis-weight calculator 64A respectively determine the paper type of the sheet of paper P, calculate the moisture content of the surface of the sheet of paper P, and calculate the basis weight of the sheet of paper P based on the intensities of the lights measured by the optical sensor 20A. Details of each determination or calculation method are described below.

The image forming conditions configuration processor 65 configures the image forming conditions for the sheet of paper P based on at least one from among the paper type of the sheet of paper P determined by the paper-type determination processor 62A, the moisture content of the surface of the sheet of paper p calculated by the moisture-content calculator 63A, and the basis weight of the sheet of paper P calculated by the basis-weight calculator 64A. Details of a configuration method of the image forming conditions by the image forming conditions configuration processor 65 are described below.

### Printing Operation of Copier 1A

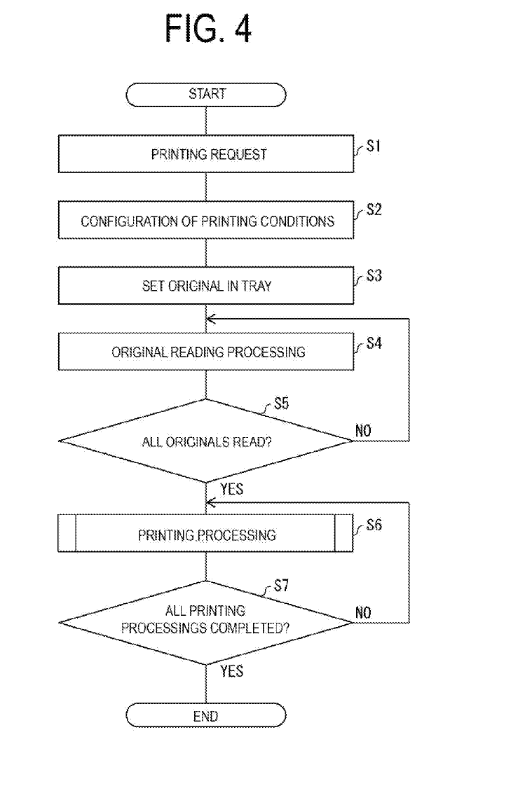

Next, a printing operation (image forming method) of the copier 1A is described with reference to FIG. 4. Here, an operation of performing double-sided printing on the same sheet of paper P using the copier 1A is described. FIG. 4 is a flowchart illustrating one example of a flow of processing of performing double-sided printing on the sheet of paper P using the copier 1A. Note that the operations described below are controlled by the controller 60A unless stated otherwise. Moreover, below, one face of the sheet of paper P is described as a first face and the other face is described as a second face.

As illustrated in FIG. 4, when the user makes a printing request (image forming request) (S1), the copier 1A configures printing conditions such as a number of sheets to be printed, a printing magnification, a size of the sheet of paper P, and single-sided/double-sided printing designated by the user (S2).

Next, the user places the original in the original tray of the scanner 2 (S3). Note that the present step may be performed before the user makes the printing request (that is, before step S1).

Next, the scanner 2 reads the original data age data) (S4). Here, an operation of reading the image data of both faces (surface and back face) of one original is described. In the operation of reading the image data, the scanner 2 reads the image data of the surface of the original. The read image data of the surface is sent to the storage memory 50 and stored in the storage memory 50. Next, the scanner 2 reads the image data of the back face of the original. The read image data of the back face is not sent to the storage memory 50 but is sent to the image processor 61. The image data of the back face of the original sent to the image processor 61 is image-processed by the image processor 61, sent to the laser scanner 13 of the image forming assembly 10, and used to print the first face of the sheet of paper P. Next, the image data of the surface of the original stored in the storage memory 50 is sent to the image processor 61. The image data of the surface of the original sent to the image processor 61 is image-processed by the image processor 61, sent to the laser scanner 13 of the image forming assembly 10, and used to print the second face of the sheet of paper P.

Next, the controller 60A determines whether image data of all originals is read (S5). In a situation where there is still an original to be read (NO at S5), the image data of the next original is read (that is, step S4 is repeated).

Meanwhile, in a situation where reading of the image data of all originals is completed (YES at S5), the copier 1A performs printing on the sheet of paper P (S6, printing processing). Details of the printing processing (S6) on the sheet of paper P by the copier 1A are described below.

Next, the controller 60A determines whether the printing processing requested by the user is completed (S7). In a situation where the requested printing is not completed (NO at S7), specifically, in a situation where printing of the number of sheets requested is not performed when there is a printing request of a plurality of sheets for one original or in a situation where printing of another original is not completed, step S6 is repeated. Meanwhile, in a situation where the requested printing is completed (YES at S7), all printing processing is completed and the copier 1A enters a standby state.

Note that the printing processing (S6) may be started before reading of all originals is completed (that is, before step S5 is completed). Generally, with copiers, there is an extremely high demand for increased printing speed, and shortening such by even a second is preferable. Because of this, it is necessary to start the printing processing without waiting for reading of the originals to be completed. Moreover, the printing processing (S6) may be started immediately after the user makes the printing request (that is, immediately after step S1). Moreover, the original reading processing (S4) and the printing processing (S6) may be performed in parallel. By this, the printing processing can be performed in a short time.

### Printing Processing of Copier 1A

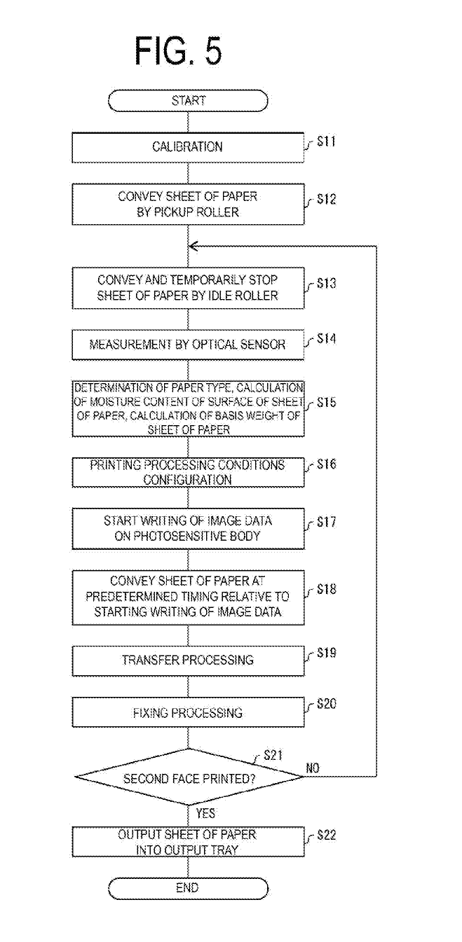

Next, the details of the printing processing (S6) on the sheet of paper P by the copier 1A are described with reference to FIG. 5. FIG. 5 is a flowchart illustrating one example of a flow of the printing processing in the copier 1A.

As illustrated in FIG. 5, in the printing processing (S6) on the sheet of paper P by the copier 1A, first, calibration is performed of acquiring the reference data used to determine the paper type of the sheet of paper P, calculate the moisture content of the surface of the sheet of paper P, and calculate the basis weight of the sheet of paper P, which are described below (S11).

Specifically, first, in a state where there is no sheet of paper P between the first illuminator 21 and the second photodetector 32 and the light source 21a of the first illuminator 21 is turned off, the first photodetector 31 and the second photodetector 32 measure an intensity of a light (that is, an intensity of a background light). The first photodetector 31 and the second photodetector 32 respectively output an electrical signal value Vb1 and an electrical signal value Vb2 of sizes in accordance with the intensity of the measured light to the storage memory 50.

Next, the light source 21a of the first illuminator 21 is turned on and held standby for a predetermined time (millisecond units) until an emission state of the light source 21a stabilizes. Next, the first photodetector 31 receives the light that is irradiated from the light source 21a and reflected by the standard reflector 40 and outputs an electrical signal value Vr1 of a size in accordance with the intensity of the received light to the storage memory 50. Moreover, at the same time, the second photodetector 32 directly receives the light irradiated from the light source 21a and outputs an electrical signal value Vr2 of a size in accordance with the intensity of the received light to the storage memory 50.

Note that in the present embodiment, the first photodetector 31 uses the light that is irradiated from the light source 21a and reflected by the standard reflector 40 to acquire the electrical signal value Vr1 as the reference data, but the disclosure is not limited thereto. In one aspect of the disclosure, an electrical signal value as the reference data may be acquired using a light reflected by a member inside the copier 1A, without using the standard reflector 40. Because as the standard reflector 40 a member that readily reflects light is used, the standard reflector 40 has an advantage where a reception amount at the first photodetector 31 is large; however, an absorbance, which is described below, can be calculated using the light reflected from the member inside the copier 1A to decrease a component count of the copier 1A.

Furthermore, the present embodiment performs calibration after the user makes the printing request but is not limited thereto. In one aspect of the disclosure, calibration may be performed once per day (for example, in early morning) such that the electrical signal value Vb1, the electrical signal value Vb2, the electrical signal value Vr1, and the electrical signal value Vr2 output in this calibration are used in that day's printing processing. In particular, in an environment such as a factory where temperature and humidity are controlled such that there is tittle change in temperature and humidity, calibration is enough once per day to be able to favorably determine the paper type of the sheet of paper P, calculate the moisture content of the surface of the sheet of paper P, and calculate the basis weight of the sheet of paper P, which are described below.

Next, as illustrated in FIG. 5, the pickup roller 4 extracts one sheet of paper P contained in the paper feed cassette 3 and conveys this sheet of paper P to the main conveyance route R1 (S12).

Next, when the sheet of paper P is conveyed down the main conveyance route R1, the pre-resist sensor 6 senses passage of the sheet of paper P and sends the sensing signal to the idle roller 5. When the idle roller 5 receives the sensing signal from the pre-resist sensor 6, the idle roller 5 temporarily retains the sheet of paper P conveyed down the main conveyance route R1 (S13).

Next, the optical sensor 20A measures the sheet of paper P retained by the idle roller 5 (S14; first measurement step, second measurement step). Specifically, first, the light source 21a of the first illuminator 21 is turned on and is held standby for the predetermined time (millisecond units) until the emission state of the light source 21a stabilizes. Next, the first photodetector 31 receives the light that is irradiated from the light source 21a and reflected or diffused by the sheet of paper P and outputs an electrical signal value Vp1 of a size in accordance with the intensity of the received light to the storage memory 50. Moreover, at the same time, the second photodetector 32 receives the light that is irradiated from the light source 21a and transmitted through the sheet of paper P and outputs an electrical signal value Vp2 of a size in accordance with the intensity of the received light to the storage memory 50.

Next, the paper-type determination processor 62A, the moisture-content calculator 63A, and the basis-weight calculator 64A respectively determine the paper type of the sheet of paper P, calculate the moisture content of the surface of the sheet of paper P, and calculate the basis weight of the sheet of paper P (S15; calculation step). Details of each determination and calculation method are described below.

Next, based on the printing conditions designated by the user, the paper type of the sheet of paper P determined by the paper-type determination processor 62A, the moisture content of the surface of the sheet of paper P calculated by the moisture-content calculator 63A, and the basis weight of the sheet of paper P calculated by the basis-weight calculator 64A, the image forming conditions configuration processor 65 configures the image forming conditions for the sheet of paper P (specifically, transfer conditions (the voltage applied to the transfer device 15, a current value supplied to the transfer device 15) and fixing conditions (the pressure whereat the pressure roller 16a pressurizes the sheet of paper P, the current that drives the heat source (halogen lamp), and the conveyance speed of the sheet of paper P when fixing)) (S16; configuration step). Further details of the configuration of the image forming conditions by the image forming conditions configuration processor 65 are described below. The image forming conditions configured by the image forming conditions configuration processor 65 are output to the transfer device 15 and the fuser 16.

Next, writing of the image data on the surface of the photoreceptor drum 11 is started (S17). Specifically, first, the laser scanner 13 forms the electrostatic latent image of the image data image-processed by the image processor 61 on the surface of the photoreceptor drum 11 charged by the charger 12. Next, the developing device 14 adheres the toner agent to the electrostatic latent image to start an operation of developing the toner image. After starting writing the image data on the surface of the photoreceptor drum 11, writing processing of the image data is continued.

Next, when writing of the image data on the surface of the photoreceptor drum 11 is started, the idle roller 5 releases retention of the sheet of paper P at the predetermined timing (S18). That is, retention of the sheet of paper P by the idle roller 5 is released so the toner image developed on the photoreceptor drum 11 is transferred to a predetermined position on the sheet of paper P by the transfer device 15.

Next, the transfer device 15 transfers the toner image developed on the photoreceptor drum 11 to the first face of the sheet of paper P (S19). Here, the transfer voltage applied to the transfer device 15 and the transfer current supplied to the transfer device 15 are the transfer voltage and the transfer current configured by the image forming conditions configuration processor 65.

Next, the fuser 16 fixes the toner image transferred to the first face of the sheet of paper P by the transfer device 15 to the sheet of paper P (S20). The pressure whereat the pressure roller 16a pressurizes the sheet of paper P, the current that drives the heat source (halogen lamp), and the conveyance speed of the sheet of paper P when fixing are configured by the image forming conditions configuration processor 65. By this, printing on the first face of the sheet of paper P is completed.

Next, the controller 60A determines whether printing is performed on the second face of the sheet of paper P (S21).

In a situation where printing on the second face is not completed (NO at S21), the sheet of paper P where the first face is printing-processed is conveyed down the main conveyance route R1 by rotation of the output roller 7 and reaches the output roller 7. When the sheet of paper P reaches the output roller 7, the sheet of paper P is temporarily retained in a state where a rear end portion in an output direction is interposed by the output roller 7. Next, the controller 60A switches the branching point to the secondary-conveyance-route R2 side. Next, the controller 60A conveys the sheet of paper P to the secondary conveyance route R2 by rotating the output roller 7 in reverse from earlier. By this, the sheet of paper P has the first face and the second face reversed compared to immediately before when passing through the image forming assembly 10 and is conveyed to between the pickup roller 4 and the optical sensor 20A on the main conveyance route R1 in the state where up and down arc reversed. Then, steps S13 to S20 are performed on the second face of the sheet of paper P to perform printing on the second face.

In a situation where printing on the second face is completed (YES at S21), the branching claw is switched to the main-conveyance-route R1 side and the sheet of paper P is conveyed to the output roller 7 from the fuser 16. Note that switching of the branching claw may be performed at any timing as long as it is after the sheet of paper P is conveyed to the secondary conveyance route R2. Next, the sheet of paper P passes through the output roller 7 and is output into the output tray (S22). By the above, printing processing (S6) on one sheet of paper P by the copier 1A is completed.

### Determination of Paper Type of Sheet of Paper P

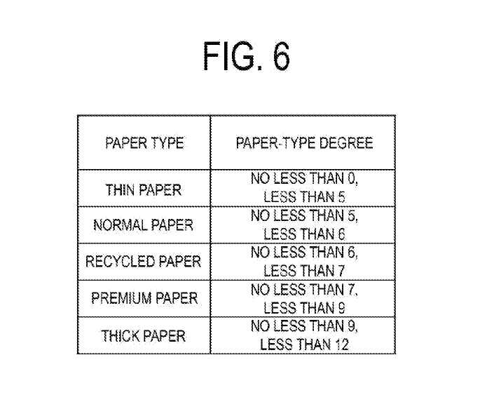

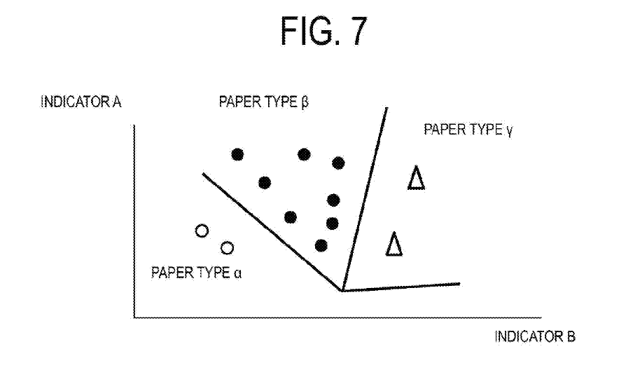

Next, the determination method of the paper type of the sheet of paper P by the paper-type determination processor 62A (step S15 in FIG. 5) is described with reference to FIG. 6 and FIG. 7.

First, the paper-type determination processor 62A calculates a first reflective absorbance Ar1 that is an absorbance of the light that is irradiated from the light source 21a and reflected or diffused by the sheet of paper P.

Specifically, first, the paper-type determination processor 62A calculates a first reference reception intensity V1r0 that is the intensity of the light that is irradiated from the light source 21a, reflected by the standard reflector 40, and received by the first photodetector 31. Note that reception intensity is a difference between an electrical signal value of a size in accordance with an intensity of a light received by a photodetector in a situation where a light source is turned on and an electrical signal value of a size in accordance with an intensity of a light received by the photodetector in a situation where the light source is turned off. Specifically, the paper-type determination processor 62A reads the electrical signal value Vb1 and the electrical signal value Vr1 measured at step S11 from the storage memory 50 and uses Equation (1) below to calculate the first reference reception intensity V1r0. The paper-type determination processor 62A outputs the calculated first reference reception intensity V1r0 to the storage memory 50.

V1r0=Vr1−Vb1 (1)

Next, the paper-type determination processor 62A calculates a first reflective reception intensity V1r that is the intensity of the light that is irradiated from the light source 21a, reflected or diffused by the sheet of paper P, and received by the first photodetector 31. Specifically, the paper-type determination processor 62A reads the electrical signal value Vb1 measured at step S11 and the electrical signal value Vp1 measured at step S14 from the storage memory 50 and calculates the first reflective reception intensity V1r using Equation (2) below. The paper-type determination processor 62A outputs the calculated first reflective reception intensity V1r to the storage memory 50.

V1r=Vp1−Vb1 (2)

Next, the paper-type determination processor 62A calculates the first reflective absorbance Ar1. Specifically, the paper-type determination processor 62A reads the first reference reception intensity V1r0 and the first reflective reception intensity V1r from the storage memory 50 and calculates the first reflective absorbance Ar1 by applying the Beer-Lambert law indicated in Equation (3) below.

Ar1=log(V1r0/V1r) (3)

The above log is a common logarithm (logarithm with a base of 10). Note that although in the present embodiment the absorbance is calculated using the Beer-Lambert law, the image forming device of the disclosure is not limited thereto; for example, the absorbance; may be calculated using the Kubelka-Munk theory.

Next, the paper-type determination processor 62A calculates a second reference reception intensity V2r0 that is the intensity of the light that is irradiated from the light source 21a and directly received by the second photodetector 32. Specifically, the paper-type determination processor 62A reads the electrical signal value Vb2 and the electrical signal value Vr2 measured at step S11 from the storage memory 50 and uses Equation (4) below to calculate the second reference reception intensity V2r0. The paper-type determination processor 62A outputs the calculated second reference reception intensity V2r0 to the storage memory 50.

V2r0=Vr2−Vb2 (4)

Next, the paper-type determination processor 62A calculates a first transmissive reception intensity V1t that is the intensity of the light that is irradiated from the light source 21a, transmitted through the sheet of paper P, and received by the second photodetector 32. Specifically, the paper-type determination processor 62A reads the electrical signal value Vb2 measured at step S11 and the electrical signal value Vp2 measured at step S14 from the storage memory 50 and calculates the first transmissive reception intensity V1t using Equation (5) below. The paper-type determination processor 62A outputs the calculated first transmissive reception intensity step S to the storage memory 50.

V1t=Vp2−Vb2 (5)

Next, the paper-type determination processor 62A calculates a first transmissive absorbance At1. Specifically, the paper-type determination processor 62A reads the second reference reception intensity V2r0 and the first transmissive reception intensity V1t from the storage memory 50 and calculates the first transmissive absorbance At1 by applying the Beer-Lambert law indicated in Equation (6) below.

At1=log(V2r0/V1t) (6)

Next, the paper-type determination processor 62A determines the paper type of the sheet of paper P using the calculated first reflective absorbance Ar1 and first transmissive absorbance At1. Specifically, the paper-type of the sheet of paper P is determined by applying the first reflective absorbance Ar1 and the first transmissive absorbance At1 in a paper-type-degree calculation formula, derived in advance and stored in the storage memory 50, that calculates a paper-type degree, which is an indicator representing a characteristic of a paper type.

As the paper-type degree above, any from among similarity (degree of similarity between measured samples), separateness (degree of difference in a characteristic between measured samples), and probability (degree of being able to stochastically determine whether, upon estimating a distribution of a characteristic of a measured sample, this distribution is in an allowable range of a distribution of another sample or able to be sufficiently distinguished, that is, as near or identical) can be used. Note that the paper-type degree can be selected as appropriate in accordance with the paper type.

As examples of a derivation method of the paper-type-degree calculation formula above, a support vector machine, pattern recognition, cluster analysis, analysis by a Mahalanobis distance, SIMCA (soft independent modeling of class analogy) determination and analysis, a canonical discriminant analysis method, and the like can be mentioned. Which derivation method of the paper-type-degree calculation formula to use is selected as appropriate in accordance with the paper type to be determined, the wavelength of the light irradiated by the first illuminator 21, a configuration of the conveyance routes of the copier 1A, and the like.

The paper-type-degree calculation formula in the present embodiment is Equation (7) below.

Paper-type degree=A1+A2×Ar1+A3×At1 (7)

Here, coefficients A1 to A3 are coefficients derived by canonical discriminant analysis based on data measured in advance by placing various paper types under various moisture-content conditions. That is, the paper-type-degree calculation formula above is a calculation formula that calculates the paper-type degree by weighting the calculated first reflective absorbance Ar1 and first transmissive absorbance At1. This weighting indicates a strength of correlation between a wavelength, an angle of reflection or transmission, and an optical-path length of a light and a paper type in measurement in the optical sensor 20A.

Next, the paper-type determination processor 62A determines the paper type of the sheet of paper P using the calculated paper-type degree. FIG. 6 is a table indicating a correspondence relationship between the paper-type degree of the sheet of paper P and the paper type of the sheet of paper P. The paper-type determination processor 62A determines the paper type of the sheet of paper P by using the table indicated in FIG. 6 to determine which paper-type range the calculated paper-type degree is in. The table indicated in FIG. 6 is created by measuring in advance paper-type degrees for various paper types at various moisture contents and is stored in the storage memory 50.

Note that although in the present embodiment the paper type of the sheet of paper P is determined using one indicator by using the table indicated in FIG. 6, the image forming device of the disclosure is not limited thereto. In one aspect of the disclosure, the paper type of the sheet of paper P may be determined by calculating a plurality of indicators. FIG. 7 is a graph used in a situation of determining the paper type of the sheet of paper P using two indicators (indicator A and indicator B). In one aspect of the disclosure, as illustrated in FIG. 7, the paper-type determination processor 62A, in a situation where, for example, a point determined by the indicator A and the indicator B is plotted as the white circle, determines that the sheet of paper P is of a paper type α. In this manner, by determining the paper type of the sheet of paper P using a plurality of indicators, determination precision can be further improved. Note that although two-dimensional plotting is performed in the graph illustrated in FIG. 7, three indicators may be used to perform three-dimensional plotting.

Whether to determine the paper type from one indicator using the table indicated in FIG. 6 or determine the paper type from a plurality of indicators using the graph illustrated in FIG. 7 is determined as appropriate according to a paper type anticipated to be handled by the image forming device and how strictly the user wishes to make the determination. Moreover, a reference value in the table indicated in FIG. 6 and a reference region in the graph illustrated in FIG. 7 are determined as appropriate in the same manner.

Here, it is known that a state of adhesion of water molecules on the surface of the sheet of paper P or a state of water molecules inside the sheet of paper P differs depending on the paper type of the sheet of paper P. Therefore, the paper-type determination processor 62A in the present embodiment determines the paper type of the sheet of paper P based on the first reflective absorbance Ar1 of the light reflected or diffused by the sheet of paper P and the first transmissive absorbance At1 of the light transmitted through the sheet of paper P. Here, the light reflected by the surface of the sheet of paper P includes information on the state of the water molecules adhered to the surface of the sheet of paper P, and the light diffused by the sheet of paper P includes information on the inside of the sheet of paper P (for example, information on the state of the water molecules inside the sheet of paper P). Moreover, the light transmitted through the sheet of paper P includes information on the thickness and the basis weight of the sheet of paper P. Therefore, the paper-type determination processor 62A can determine the paper type by considering the moisture content, the information on the inside, the thickness, and the basis weight of the sheet of paper P by using the first reflective absorbance Ar1 and the first transmissive absorbance At1. As a result, the paper type of the sheet of paper P can be precisely determined.

In the related art, paper type is determined from an intensity of a light transmitted through the sheet of paper P or an intensity of a light reflected or diffused by the sheet of paper P. Because an importance of these light intensities changes according to paper type, precision of determining the sheet of paper P is low. In contrast, the copier 1A in the present embodiment improves determination precision by using the paper-type-degree calculation formula above to create a comprehensive indicator called a “paper-type degree” by associating the intensity of the light transmitted through the sheet of paper P and the intensity of the light reflected or diffused by the sheet of paper P.

For example, in the related art, paper-type determination can only be performed when materials and glossiness clearly differ as with normal paper and OHP paper; however, with the copier 1A of the present embodiment, as illustrated in FIG. 6, the paper type can be determined even with sheets of paper of similar materials, such as normal paper and premium paper.

### Calculation of Moisture Content of Sheet of Paper P

Next, the calculation method of the moisture content of the surface of the sheet of paper P by the moisture-content calculator 63A (step S15 in FIG. 5) is described.

First, the moisture-content calculator 63A reads the first reflective absorbance Ar1 and the first transmissive absorbance At1 calculated by the paper-type determination processor 62A from the storage memory 50.

Next, the moisture-content calculator 63A calculates the moisture content of the surface of the sheet of paper P by applying the first reflective absorbance Ar1 and the first transmissive absorbance At1 in a moisture-content calculation formula that is derived in advance and stored in the storage memory 50.

The moisture-content calculation formula in the present embodiment is Equation (8) below.

Moisture content=B1+B2×Ar1+B3×At1 (8)

Here, coefficients B1 to B3 are coefficients determined according to conditions such as the wavelength of the light irradiated by the first illuminator 21, the paper type of the sheet of paper P, and an internal configuration of the copier 1A, and coefficients for various conditions are sought in advance by multiple regression analysis and stored in the storage memory 50. The coefficients B1 to B3 are sought by multiple regression analysis based on data measured by placing various paper types under various moisture-content conditions.

As above, the moisture-content calculator 63A calculates the moisture content of the surface of the sheet of paper P based on the first reflective absorbance Ar1 of the light reflected or diffused by the sheet of paper P and the first transmissive absorbance At1 of the light transmitted through the sheet of paper P. As a result, the moisture content of the surface of the sheet of paper P can be calculated by considering various information on the sheet of paper P (such as the information on the inside, the thickness, and the basis weight). As a result, the moisture content of the surface of the sheet of paper P can be precisely calculated.

In the related art, data measuring an attenuation amount of a transmitted light amount and an angular dependence of a reflected light is prepared in advance according to paper type and this data and measured values are compared. Because of this, moisture content can only be calculated for a paper type that is already known. In contrast, in the present embodiment, by using Equation (8) above, the moisture content of the surface of the sheet of paper P can be calculated even for a paper type where data is not prepared in advance.

Furthermore, it is known that absorbance is substantially proportional to a component amount included in a measurement target. As a result, the moisture content of the sheet of paper P can be readily reflected in the coefficients B1 to B3. By this, the moisture content of the surface of the sheet of paper P can be precisely calculated.

Furthermore, in the present embodiment, the moisture content of the surface of the sheet of paper P is calculated after determining the paper type of the sheet of paper P. By this, a moisture-content calculation formula in correspondence with the paper type determined by the paper-type determination processor 62A can be used; therefore, the moisture content of the surface of the sheet of paper P can be more precisely calculated. Note that in one aspect of the disclosure, the moisture-content calculator 63A may calculate the moisture content of the surface of the sheet of paper P without reflecting the paper type determined by the paper-type determination processor 62A.

Note that the moisture content of the surface of the sheet of paper P can be calculated using not absorbance but transmittance or reflectance. However, because transmittance and reflectance are not proportional to a component amount included in a measurement target, it is difficult for information on components that differ according to paper type to be reflected. Because of this, precision decreases compared to calculation using absorbance and an equation for calculating the moisture content becomes a complex equation.

Furthermore, with the copier 1A, the moisture-content calculation formula is sought by multiple regression analysis when calculating the moisture content of the surface of the sheet of paper P, but the image forming device of the disclosure is not limited thereto. That is, the moisture-content calculation formula in the image forming device of one aspect of the disclosure may seek this using another analysis means as long as it is a multivariate analysis means that can calculate the moisture content of the surface of the sheet of paper P using a plurality of absorbances. For example, the moisture-content calculation formula may be sought using another analysis means such as PLS (partial linear square) regression analysis as the analysis means.

### Calculation of Basis Weight of Sheet of Paper P

Next, the calculation method of the basis weight of the sheet of paper P by the basis-weight calculator 64A (step S15 in FIG. 5) is described.

First, the basis-weight calculator 64A reads the first reflective absorbance Ar1 and the first transmissive absorbance At1 calculated by the paper-type determination processor 62A from the storage memory 50.

Next, the basis-weight calculator 64A calculates the basis weight of the sheet of paper P by applying the first reflective absorbance Ar1 and the first transmissive absorbance At1 in a basis-weight calculation formula that is derived in advance and stored in the storage memory 50.

The basis-weight calculation formula in the present embodiment is Equation (9) below.

Basis weight=C1+C2×Ar1+C3×At1 (9)

Here, coefficients C1 to C3 are coefficients determined according to conditions such as the wavelength of the light irradiated by the first illuminator 21, the paper type of the sheet of paper P, and the internal configuration of the copier 1A, and coefficients for various conditions are sought in advance by multiple regression analysis and stored in the storage memory 50. The coefficients C1 to C3 are sought by multiple regression analysis based on data measured by placing various paper types under various moisture-content conditions.

As above, the basis-weight calculator 64A calculates the basis weight of the sheet of paper P based on the first reflective absorbance Ar1 of the light reflected or diffused by the sheet of paper P and the first transmissive absorbance At1 of the light transmitted through the sheet of paper P. As a result, the basis weight of the sheet of paper P can be calculated by considering various information on the sheet of paper P (such as the moisture content, the information on the inside, and the thickness). As a result, the basis weight of the sheet of paper P can be precisely calculated.

In the related art, data measuring an attenuation amount of a transmitted light amount and an angular dependence of a reflected light is prepared in advance according to paper type and this data and measured values are compared. Because of this, basis weight can only be calculated for a paper type that is already known. In contrast, in the present embodiment, by using Equation (9) above, the basis weight of the sheet of paper P can be calculated even for a paper type where data is not prepared in advance.

Furthermore, it is known that absorbance is substantially proportional to a component amount included in a measurement target; a weight of a component contained in the sheet of paper P affects the basis weight. As a result, component amounts of various components included in the sheet of paper P can be readily reflected in the coefficients C1 to C3. By this, the basis weight of the sheet of paper P can be precisely calculated.

Furthermore, in the present embodiment, the basis weight of the sheet of paper P is calculated after determining the paper type of the sheet of paper P. By this, a basis-weight calculation formula in correspondence with the paper type determined by the paper-type determination processor 62A can be used; therefore, the basis weight of the sheet of paper P can be more precisely calculated. Note that in one aspect of the disclosure the basis-weight calculator 64A may calculate the basis weight of the sheet of paper P without reflecting the paper type determined by the paper-type determination processor 62A.

Note that the basis weight of the sheet of paper P can be calculated using not absorbance but transmittance or reflectance. However, because transmittance and reflectance are not proportional to a component amount included in a measurement target, it is difficult for information on components that differ according to paper type to be reflected. Because of this, precision decreases compared to calculation using absorbance and an equation for calculating the basis weight becomes a complex equation.

### Configuration of Image Forming Conditions

Next, the configuration method of the image forming conditions by the image forming conditions configuration processor 65 (step S16 in FIG. 5) is described.

In the configuration of the image forming conditions by the image forming conditions configuration processor 65, the image forming conditions configuration processor 65 configures the image forming conditions based on the printing conditions designated by the user as well as the paper type of the sheet of paper P determined by the paper-type determination processor 62A, the moisture content of the surface of the sheet of paper P calculated by the moisture-content calculator 63A, and the basis weight of the sheet of paper P calculated by the basis-weight calculator 64A.

More specifically, image forming conditions are configured in advance for each paper type of the sheet of paper P determined by the paper-type determination processor 62A, each predetermined range of the moisture content of the surface of the sheet of paper P calculated by the moisture-content calculator 63A, and each predetermined range of the basis weight of the sheet of paper P calculated by the basis-weight calculator 64A and stored in the storage memory 50. The image forming conditions configuration processor 65 configures the image forming conditions based on the image forming conditions configured in advance, the paper type of the sheet of paper P, the moisture content of the surface of the sheet of paper P, and the basis weight of the sheet of paper P.

With the copier 1A, because the moisture content of the surface of the sheet of paper P is precisely calculated, the image forming conditions configuration processor 65 can configure the image forming conditions in a range of, for example, 1% increments of a moisture content of a surface of the first face of the sheet of paper P.

Note that with the image forming device in one aspect of the disclosure, the image forming conditions configuration processor 65 may configure at least one value from among the voltage applied to the transfer device 15, the current supplied to the transfer device 15, the pressure whereat the pressure roller 16a pressurizes the sheet of paper P, the current that drives the heat source (halogen lamp), and the conveyance speed of the sheet of paper P when fixing. The transfer conditions and fixing conditions configured by the image forming conditions configuration processor 65 are output to the image forming assembly 10 (more specifically, the transfer device 15 and the fuser 16).

As above, with the copier 1A in the present embodiment, the paper type of the sheet of paper P, the moisture content of the surface of the sheet of paper P, and the basis weight of the sheet of paper P are determined and calculated based on the intensity of the light reflected or diffused by the sheet of paper P and the intensity of the light transmitted through the sheet of paper P. As a result, the paper type of the sheet of paper P, the moisture content of the surface of the sheet of paper P, and the basis weight of the sheet of paper P can be determined and calculated by considering various information on the sheet of paper P (such as the information on the inside, the thickness, and the basis weight). As a result, the paper type of the sheet of paper P, the moisture content of the surface of the sheet of paper P, and the basis weight of the sheet of paper P can be precisely calculated and determined. Therefore, appropriate image forming conditions can be configured.

Note that in the present embodiment, the image forming conditions configuration processor 65 configures the image forming conditions based on the paper type of the sheet of paper P, the moisture content of the surface of the sheet of paper P, and the basis weight of the sheet of paper P, but the image forming device of the disclosure is not limited thereto. That is, with the image forming device in one aspect of the disclosure, the image forming conditions may be configured based on at least one from among the paper type of the sheet of paper P, the moisture content of the surface of the sheet of paper P, and the basis weight of the sheet of paper P.

Furthermore, with the optical sensor 20A in the present embodiment, the first illuminator 21 irradiates the light reflected or diffused by the sheet of paper P and the light transmitted through the sheet of paper P. By this, a number of illuminators in the optical sensor 20A can be made to be one (that is, there is no need to provide two illuminators); therefore, the configuration of the optical sensor 20A (in other words, the copier 1A) can be simplified.

Furthermore, the copier 1A in the present embodiment is of a configuration where the optical sensor 20A measures the sheet of paper P when the sheet of paper P is temporarily retained by the idle roller 5. lay this, time required for printing can be shortened.

Furthermore, in the present embodiment, because the wavelength of the light irradiated by the light source 21a is from 800 to 1100 nm, the light irradiated by the light source 21a can penetrate inside the sheet of paper P and is readily absorbed by moisture. By this, more information on the moisture included in the sheet of paper P can be obtained. Therefore, the paper type of the sheet of paper P, the moisture content of the surface of the sheet of paper P, and the basis weight of the sheet of paper P can be precisely determined and calculated.

Note that the image forming device in one aspect of the disclosure may be further provided with a temperature sensor and correct each electrical signal value, the paper-type-degree calculation formula, the moisture-content calculation formula, and basis-weight calculation in the calibration above by a temperature measured by the temperature sensor. By this, a frequency of calibration can be decreased.

Furthermore, with the present embodiment, as aspect is described of printing on both faces of the sheet of paper P, but one aspect of the disclosure may be an aspect where printing is performed only on one face of the sheet of paper P.

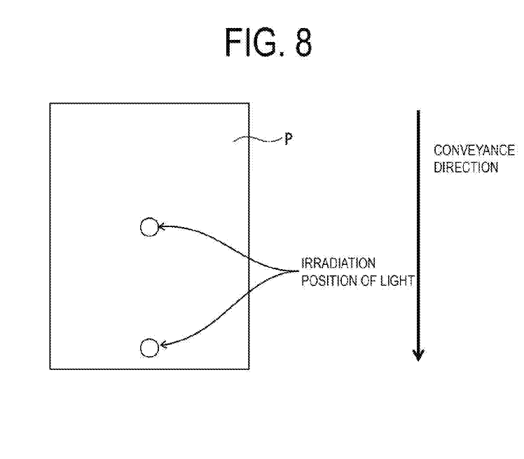

Furthermore, generally, paper (the sheet of paper P) has a property where an end. portion more readily contains moisture than a central portion. That is, the moisture content of the sheet of paper P is distributed according to location. Therefore, with the copier 1A of one aspect of the disclosure, the distribution of the moisture content of the sheet of paper P may be considered to irradiate the light in a plurality of locations. FIG. 8 is a top view of the sheet of paper P illustrating irradiation locations of the light on the sheet of paper P by the optical sensor 20A. As illustrated in FIG. 8, the first illuminator 21 of the optical sensor 20A irradiates the light to two locations on the sheet of paper P. Specifically, first, the first illuminator 21 performs a first measurement by irradiating the light to the sheet of paper P retained by the idle roller 5. Next, the sheet of paper P is conveyed a predetermined amount by the idle roller 5 and the sheet of paper P is retained again. Then, the first illuminator 21 performs a second measurement by irradiating the light to the sheet of paper P in a position different from the first irradiation position. With the first irradiation position and the second irradiation position, one is the central portion of the sheet of paper P and the other is an end portion of the sheet of paper P. That is, the optical sensor 20A performs measurement at the central portion and an end portion of the sheet of paper P. By this, the paper-type determination processor 62A can calculate the first reflective absorbance Ar1 and the first transmissive absorbance At1 using an average value of a first measurement result and a second measurement result; therefore, an influence of the distribution of the moisture content of the surface of the sheet of paper P on the first reflective absorbance Ar1 and the first transmissive absorbance At1 can be decreased. Note that there may be three or more irradiation locations of the light on the sheet of paper P by the optical sensor 20A.

Furthermore, in the present embodiment, measurement of the sheet of paper P and configuration of the printing processing conditions are performed for each sheet, but the disclosure is not limited thereto. In one aspect of the disclosure, measurement of the sheet of paper P and configuration of the printing processing conditions may be performed every few sheets when, for example, printing a large volume at once.

Furthermore, in the present embodiment, the copier 1A is described as the image forming device, but the image forming device of the disclosure is not limited to a copier. The image forming device may be, for example, a commercial printing press, a printer, or a facsimile device. In a situation where the image forming device is a commercial printing press or a facsimile device, the image forming device performs processing of receiving the image data as data via a network instead of the original-reading processing (step S4 in FIG. 4).

Furthermore, the copier 1A of the present embodiment is of a configuration provided with one photoreceptor drum. However, the image forming device of the disclosure is not limited thereto. The image forming device of one aspect of the disclosure may be an image forming device that can perform color printing on the sheet of paper P.

### Modified Example 1

Next, a paper-type determination processor 62A as a modified example of Embodiment 1 is described with reference to the drawings.

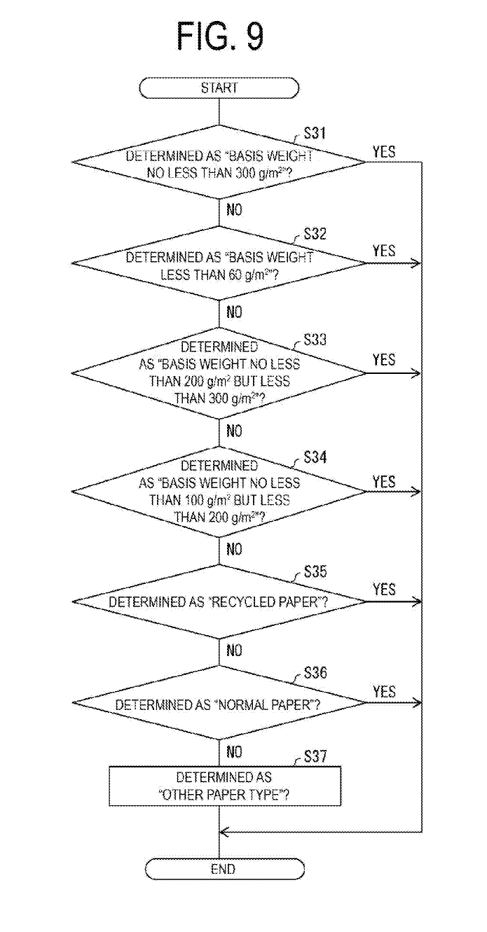

FIG. 9 is a flowchart illustrating one example of a flow of processing of the paper-type determination processor 62A in the present modified example determining the paper type of the sheet of paper P.

The paper-type determination processor 62A in Embodiment 1 uses one paper-type-degree calculation formula to determine which of a plurality of paper types the sheet of paper P is. In contrast, the paper-type determination processor 62A in the present modified example uses a plurality of paper-type-degree calculation formulas to incrementally determine the paper type of the sheet of paper P.

In the present modified example, the paper-type determination processor 62A uses six paper-type-degree calculation formulas, F1 to F6. The paper-type-degree calculation formulas F1 to F6 are stored in advance in the storage memory 50. The paper-type-degree calculation formulas F1 to F6 have different coefficients A1 to A3 in Equation (3). The paper-type-degree calculation formula F1 is a calculation formula for determining whether the sheet of paper P is of a paper type where the basis weight is no less than 300 g/m². The paper-type-degree calculation formula F2 is a calculation formula for determining whether the sheet of paper P is of a paper type where the basis weight is less than 60 g/m². The paper-type-degree calculation formula F3 is a calculation formula for determining whether the sheet of paper P is of a paper type where the basis weight is no less than 200 g/m² but less than 300 g/m². The paper-type-degree calculation formula F4 is a calculation formula for determining whether the sheet of paper P is of a paper type where the basis weight is no less than 100 g/m² but less than 200 g/m². The paper-type-degree calculation formula F5 is a calculation formula for determining whether the sheet of paper P is recycled paper. The paper-type-degree calculation formula F6 is a calculation formula for determining whether the sheet of paper P is normal paper.

As illustrated in FIG. 9, the paper-type determination processor 62A in the present modified example first calculates the paper-type degree using the paper-type-degree calculation formula F1 and, by determining whether the calculated paper-type degree is within the predetermined range, determines whether the sheet of paper P is of the paper type whose basis weight is no less than 300 g/m² (S31). In a situation where the calculated paper-type degree is within the predetermined range (YES at S31), the paper type of the sheet of paper P is determined to be the paper type where the basis weight of the sheet of paper P is no less than 300 g/m².

Meanwhile, in a situation where the calculated paper-type degree is not within the predetermined range (NO at S31), the paper-type determination processor 62A calculates the paper-type degree using the paper-type-degree calculation formula F2 and, by determining whether the calculated paper-type degree is within the predetermined range, determines whether the sheet of paper P is the paper type whose basis weight is less than 60 g/m² (S32).

Thereafter, the paper-type determination processor 62A similarly performs processing similar to step S31 using the paper-type-degree calculation formula F3 for determining whether the basis weight of the sheet of paper P is no less than 200 g/m² but less than 300 g/m² (S33), the paper-type-degree calculation formula F4 for determining whether the basis weight of the sheet of paper P is no less than 100 g/m² but less than 200 g/m² (S34), the paper-type-degree calculation formula F5 for determining whether the sheet of paper P is recycled paper (S35), and the paper-type-degree calculation formula F6 for determining whether the sheet of paper is normal paper (S36).

Furthermore, in a situation where it is determined at step S36 that the sheet of paper P is not normal paper, the paper-type determination processor 62A determines that the sheet of paper P is of “another paper type” that is none of these paper types (S37). Note that in this situation, the paper-type determination processor 62A may determine that the sheet of paper P is of a paper type that cannot be used in the copier 1A.

Determination is easy for extremely thick paper whose basis weight is, for example, no less than 300 g/m² because many of these paper types have similar surface smoothness and are readily distinguished from characteristics of other paper types. Meanwhile, because recycled paper is manufactured by mixing and recycling various paper, components are varied, and a thickness is near that of normal paper; it is a paper type where determination is difficult. Therefore, the paper-type determination processor 62A in the present modified example determines the paper type of the sheet of paper P incrementally starting from paper types that have characteristic features and are readily determined. By this, the paper type of the sheet of paper P can be precisely determined.

### Modified Example 2

Next, a copier 1B as a modified example of Embodiment 1 is described with reference to the drawings. Note that for convenience in description, members having the same functions as members described in Embodiment 1 are labeled with the same reference signs and description thereof is omitted.

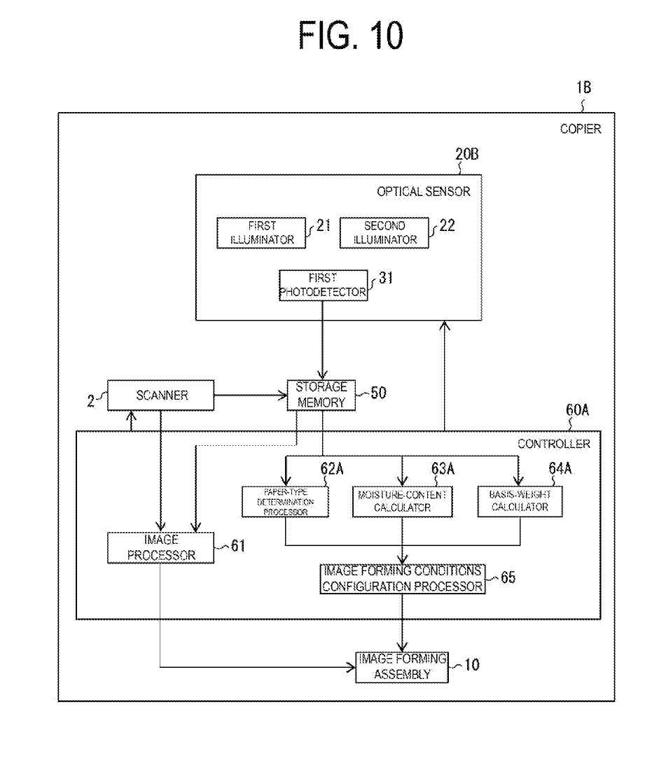

FIG. 10 is a block diagram illustrating a configuration of a main portion of the copier 1B. As illustrated in FIG. 10, the copier 1B is provided with an optical sensor 20B instead of the optical sensor 20A in the copier 1A in Embodiment 1.

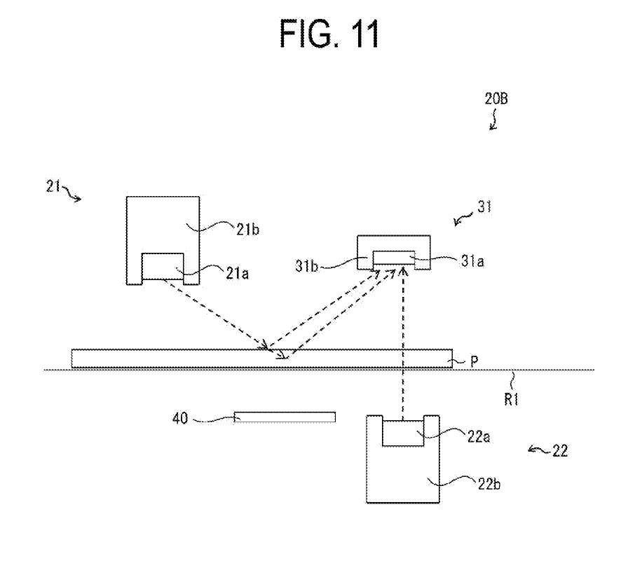

FIG. 11 is a schematic view illustrating a configuration of the optical sensor 20B. As illustrated in FIG. 10 and FIG. 11, the optical sensor 20B is provided with the first illuminator (first illuminator) 21, a second illuminator (second illuminator) 22, and the first photodetector (transmitted-light photodetector, reflected-light photodetector) 31.

In the present modified example, as illustrated in FIG. 11, the light irradiated from the first illuminator 21 is reflected or diffused by the sheet of paper P and received by the first photodetector 31.

The second illuminator 22 is provided on the opposite side of the first illuminator 21 in relation to the main conveyance route R1. The second illuminator 22 is provided with one light source 22a and a housing 22b that houses the light source 22a. Because a configuration of the second illuminator 22 is similar to the configuration of the first illuminator 21, description thereof is omitted. A light irradiated from the second illuminator 22 is transmitted through the sheet of paper P and received by the first photodetector 31. A wavelength of the light irradiated by the light source 22a of the second illuminator 22 may be identical to or different from the wavelength of the light irradiated from the light source 21a of the first illuminator 21.

As illustrated in FIG. 11, the first photodetector 31 is provided on the same side as the first illuminator 21 in relation to the main conveyance route R1. The first photodetector 31 receives the light that is irradiated from the first illuminator 21 and reflected or diffused by the sheet of paper P and the light that is irradiated from the second illuminator 22 and transmitted through the sheet of paper P.

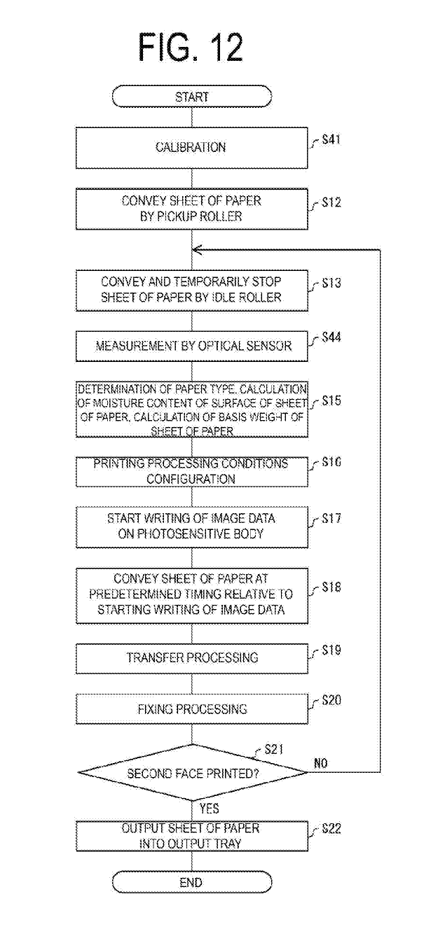

Next, printing processing (step S6 illustrated in FIG. 4) of the copier 1B is described with reference to FIG. 12. FIG. 12 is a flowchart illustrating one example of a flow of printing processing in the copier 1B.

As illustrated in FIG. 12, in printing processing (S6) on the sheet of paper P by the copier 1B, first, calibration is performed that acquires the reference data (S41).

Specifically, first, in a state where the sheet of paper P is not between the second illuminator 22 and the first photodetector 31 and the light source 21a of the first illuminator 21 and the light source 22a of the second illuminator 22 are turned off, the first photodetector 31 measures the intensity of the light (that is, the intensity of the background light). The first photodetector 31 outputs the electrical signal value Vb1 of the size in accordance with the intensity of the measured light to the storage memory 50.

Next, the light source 21a of the first illuminator 21 is turned on and held standby for the predetermined time (millisecond units) until the emission state of the light source 21a stabilizes. Next, the first photodetector 31 receives the light that is irradiated from the light source 21a and reflected by the standard reflector 40 and outputs the electrical signal value Vr1 of the size in accordance with the intensity of the received light to the storage memory 50.

Next, the light source 21a of the first illuminator 21 is turned off. Next, the light source 22a of the second illuminator 22 is turned on and held standby for a predetermined time (millisecond units) until an emission state of the light source 22a stabilizes. Next, the first photodetector 31 directly receives the light irradiated from the light source 22a and outputs the electrical signal value Vr2 of the size in accordance with the intensity of the received light to the storage memory 50.

Next, step S12 and step S13 are performed. Because step S12 and step S13 are similar to those in Embodiment 1, description thereof is omitted.

Next, the optical sensor 20B measures the sheet of paper P retained by the idle roller 5 (S44). Specifically, first, the light source 21a of the first illuminator 21 is turned on and held standby for the predetermined time (millisecond units) until the emission state of the light source 21a stabilizes. Next, the first photodetector 31 receives the light that is irradiated from the light source 21a and reflected or diffused by the sheet of paper P and outputs the electrical signal value Vp1 of the size in accordance with the intensity of the received light to the storage memory 50.

Next, the light source 21a of the first illuminator 21 is turned off. Next, the light source 22a of the second illuminator 22 is turned on and held standby the predetermined time (millisecond units) until the emission state of the light source 22a stabilizes. Next, the first photodetector 31 receives the light that is irradiated from the light source 22a and transmitted through the sheet of paper P and outputs the electrical signal value Vp2 of the size in accordance with the intensity of the received light to the storage memory 50.

Because subsequent processing (steps S15 to S22) is similar to that in Embodiment 1, description thereof is omitted.

As above, in the present modified example as well, the paper type of the sheet of paper P, the moisture content of the surface of the sheet of paper P, and the basis weight of the sheet of paper P are determined and calculated based on the intensity of the light reflected or diffused by the sheet of paper P and the intensity of the light transmitted through the sheet of paper P. As a result, the paper type of the sheet of paper P, the moisture content of the surface of the sheet of paper P, and the basis weight of the sheet of paper P can be determined and calculated by considering various information on the sheet of paper P (such as the information on the inside, the thickness, and the basis weight). As a result, the paper type of the sheet of paper P, the moisture content of the surface of the sheet of paper P, and the basis weight of the sheet of paper P can be precisely calculated and determined. Therefore, appropriate image forming conditions can be configured.

Furthermore, with the optical sensor 20B in the present embodiment, the first photodetector 31 receives the light reflected or diffused by the sheet of paper P and the light transmitted through the sheet of paper P. By this, a number of photodetectors in the optical sensor 20B can be made to be one (that is, there is no need to provide two photodetectors); therefore, the configuration of the optical sensor 20B can be simplified.

### Embodiment 2

Another embodiment of the disclosure is described below. Note that for convenience in description, members having the same function as members described in the previous embodiment are labeled with the same reference signs and description thereof is omitted.

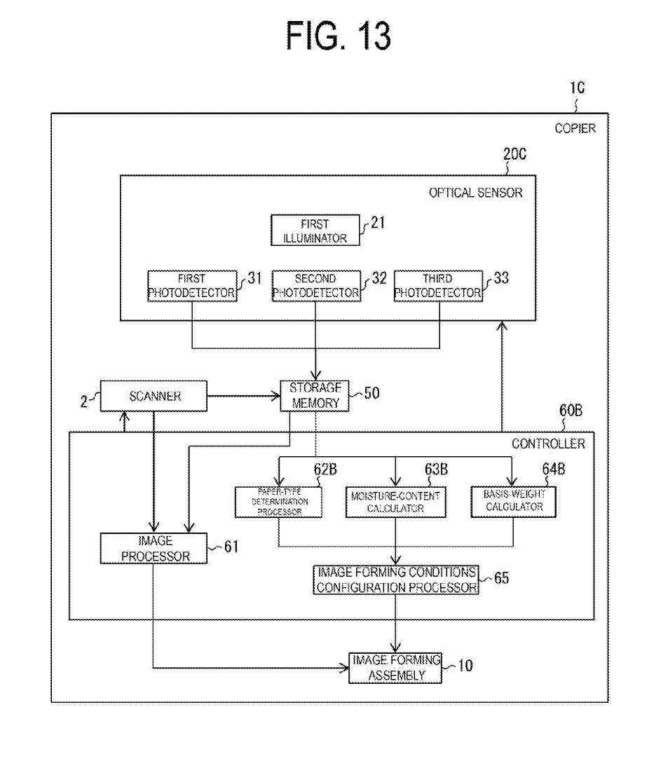

FIG. 13 is a block diagram illustrating a configuration of a main portion of a copier 1C in the present embodiment. As illustrated in FIG. 13, the copier 1C is provided with an optical sensor 20C and a controller 60B instead of the optical sensor 20A and the controller 60A in the copier 1A of Embodiment 1.

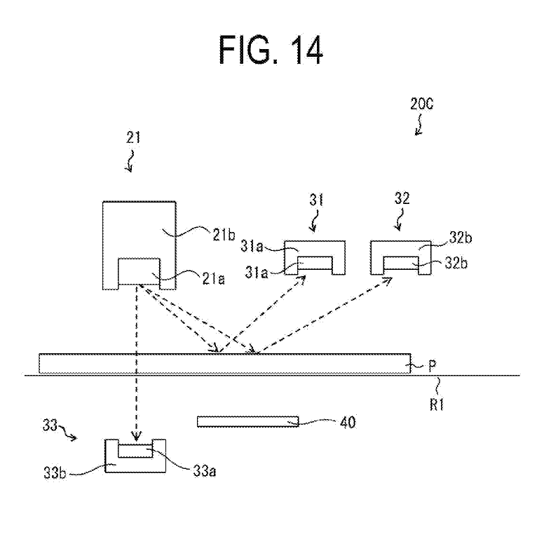

FIG. 14 is a schematic view illustrating a configuration of the optical sensor 20C. Note that FIG. 14 omits illustrating the light diffused by the sheet of paper P for simplification (likewise in subsequent drawings). As illustrated in FIG. 13 and FIG. 14, the optical sensor 20C is provided with the first illuminator (first illuminator, second illuminator) 21, the first photodetector (first reflected-light photodetector) 31, the second photodetector (second reflected-light photodetector) 32, and a third photodetector (transmitted-light photodetector) 33.

The first photodetector 31 is provided on the same side as the first illuminator 21 in relation to the main conveyance route R1. The first photodetector 31 receives the light that is irradiated from the first illuminator 21 and reflected or diffused by the sheet of paper P.

The second photodetector 32 is provided on the same side as the first illuminator 21 in relation to the main conveyance route R1 and disposed lined up with the first photodetector 31 along the direction wherein the sheet of paper P is conveyed. The second photodetector 32 receives the light that is irradiated from the first illuminator 21 and reflected or diffused by the sheet of paper P at an angle different from an angle whereat the first photodetector 31 receives the light.

The third photodetector 33 receives the light that is irradiated from the first illuminator 21 and transmitted through the sheet of paper P. The third photodetector 33 is provided on the opposite side of the first illuminator 21 in relation to the main conveyance route R1. The third photodetector 33 is provided with one light receiving device 33a and a housing 33b that houses the light receiving device 33a. Because a configuration of the third photodetector 33 is similar to the configuration of the first photodetector 31, description thereof is omitted.

The controller 60B is provided with a paper-type determination processor 62B, a moisture-content calculator 63B, and a basis-weight calculator 64B instead of the paper-type determination processor 62A, the moisture-content calculator 63A, and the basis-weight calculator 64A in the controller 60A of Embodiment 1.

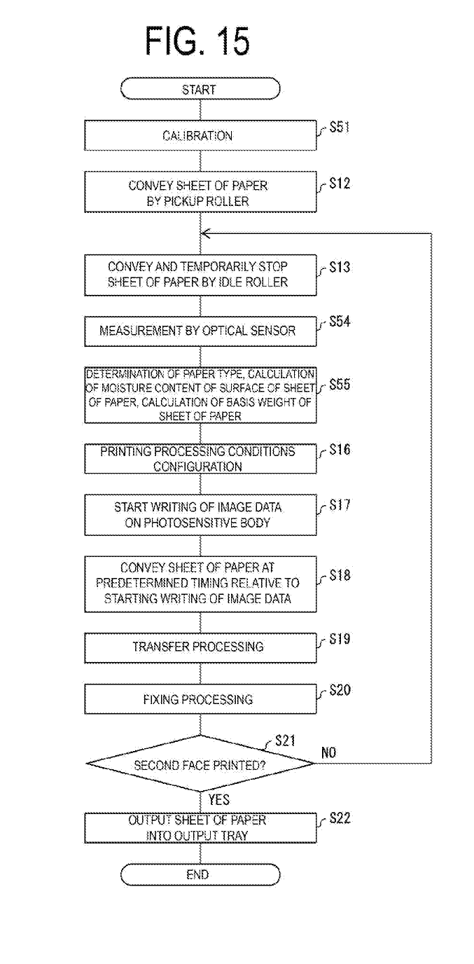

Next, printing processing (step S6 illustrated in FIG. 4) of the copier 1C is described with reference to FIG. 15. FIG. 15 is a flowchart illustrating one example of a flow of printing processing in the copier 1C.

As illustrated in FIG. 15, in printing processing (S6) on the sheet of paper P by the copier 1C, first, calibration is performed that acquires the reference data (S51).

Specifically, first, a state where the sheet of paper P is not between the first illuminator 21 and the third photodetector 33 and the light source 21a of the first illuminator 21 is turned off, the first photodetector 31, the second photodetector 32, and the third photodetector 33 measure the intensity of the light (that is, the intensity of the background light). The first photodetector 31, the second photodetector 32, and the third photodetector 33 respectively output the electrical signal value Vb1, the electrical signal value Vb2, and an electrical signal value Vb3 of sizes in accordance with the intensity of the measured light to the storage memory 50.

Next, the light source 21a of the first illuminator 21 is turned on and held standby for the predetermined time (millisecond units) until the emission state of the light source 21a stabilizes. Next, the first photodetector 31 and the second photodetector 32 receive a portion of the light that is irradiated from the light source 21a and reflected by the standard reflector 40 and respectively output the electrical signal value Vr1 and the electrical signal value Vr2 of the sizes in accordance with the intensity of the received tight to the storage memory 50. Moreover, at the same time, the third photodetector 33 directly receives a portion of the light irradiated from the light source 21a and outputs an electrical signal value Vr3 of a size in accordance with the intensity of the received light to the storage memory 50.

Next, step S12 and step S13 are performed. Because step S12 and step S13 are similar to those in Embodiment 1, description thereof is omitted.

Next, the optical sensor 20C measures the sheet of paper P retained by the idle roller 5 (S54). Specifically, first, the light source 21a of the first illuminator 21 is turned on and held standby for the predetermined time (millisecond units) until the emission state of the light source 21a stabilizes. Next, the first photodetector 31 and the second photodetector 32 receive the light that is irradiated from the light source 21a and reflected or diffused by the sheet of paper P and output the electrical signal value Vp1 and the electrical signal value Vp2 of the sizes in accordance with the intensity of the received light to the storage memory 50. Moreover, at the same time, the third photodetector 33 receives a portion of the light that is irradiated from the light source 21a and transmitted through the sheet of paper P and outputs an electrical signal value Vp3 of a size in accordance with the intensity of the received light to the storage memory 50.

Next, the paper-type determination processor 62B, the moisture-content calculator 63B, and the basis-weight calculator 64B respectively determine the paper type of the sheet of paper P, calculate the moisture content of the surface of the sheet of paper P, and calculate the basis weight of the sheet of paper P (S55). Details of each determination and calculation method are described below.

Because subsequent processing (steps S16 to S22) is similar to that in Embodiment 1, description thereof is omitted.

### Determination of Paper Type of Sheet of Paper P

Next, the determination method of the paper type of the sheet of paper P by the paper-type determination processor 62B is described.

First, the paper-type determination processor 62B calculates the first reflective absorbance Ar1 and a second reflective absorbance Ar2, which are absorbances of the light that is irradiated from the light source 21a, reflected or diffused by the sheet of paper P, and received by the first photodetector 31 and the second photodetector 32. Because a calculation method of the first reflective absorbance Ar1 and the second reflective absorbance Ar2 is similar to the calculation method described in Embodiment 1, description thereof is omitted. However, when using the calculation method described in Embodiment 1, calculation is performed by switching the reference signs and subscripts of the measured electrical signal values (such as “r2” in Ar2) to reference signs where the reference signs and subscripts in the calculation method described in Embodiment 1 are made to correspond with the present embodiment. As above, absorbance is calculated by log ((intensity of light when sheet of paper P is absent−intensity of background light)/(intensity of light when light is irradiated to sheet of paper P−intensity of background light)), and the light-intensity measurement values substituted into this equation are measured by the same combinations of light sources and light receiving devices (the same light receiving devices in the situation of the intensity of the background light). Therefore, calculation is performed by switching the subscripts to those in correspondence with these combinations. With each subsequent embodiment as well, calculation of absorbance is performed by switching to subscripts in correspondence with each embodiment.

Next, the paper-type determination processor 62B calculates the first transmissive absorbance At1, which is an absorbance of the light that is irradiated from the light source 21a, transmitted through the sheet of paper P, and received by the third photodetector 33. Because the calculation method of the first transmissive absorbance At1 is similar to the calculation method described in Embodiment 1, description thereof is omitted.

Next, the paper-type determination processor 62B determines the paper type of the sheet of paper P by applying the calculated first reflective absorbance Ar1, second reflective absorbance Ar2, and first transmissive absorbance At1 in a paper-type-degree calculation formula that is derived in advance and stored in the storage memory 50.

The paper-type-degree calculation formula in the present embodiment is Equation (10) below.

Paper-type degree=A4+A5×Ar1+A6×Ar2+A7×At1 (10)

Here, coefficients A4 to A7 are coefficients derived by canonical discriminant analysis based on data measured in advance by placing various paper types under various moisture-content conditions.

Next, the paper-type determination processor 62B determines the paper type of the sheet of paper P by determining which paper-type range the calculated paper-type degree is in.

### Calculation of Moisture Content of Sheet of Paper P

Next, the calculation method of the moisture content of the surface of the sheet of paper P by the moisture-content calculator 63B is described.

First, the moisture-content calculator 63B reads the first reflective absorbance Ar1, the second reflective absorbance Ar2, and the first transmissive absorbance At1 calculated by the paper-type determination processor 62B from the storage memory 50.

Next, the moisture-content calculator 63B calculates the moisture content of the surface of the sheet of paper P by applying the first reflective absorbance Ar1, the second reflective absorbance Ar2, and the first transmissive absorbance At1 in a moisture-content calculation formula that is derived in advance and stored in the storage memory 50.

The moisture-content calculation formula in the present embodiment is Equation (11) below.

Moisture content=B4+B5×Ar1+B6×Ar2+B7×At1 (11)

Here, coefficients B4 to B7 are coefficients determined according to conditions such as the wavelength of the light irradiated by the first illuminator 21, the paper type of the sheet of paper P, and an internal configuration of the copier 1C, and coefficients for various conditions are sought in advance by multiple regression analysis and stored in the storage memory 50.

### Calculation of Basis Weight of Sheet of Paper P

Next, the calculation method of the basis weight of the sheet of paper P by the basis-weight calculator 64B is described.

First, the basis-weight calculator 64B reads the first reflective absorbance Ar1, the second reflective absorbance Ar2, and the first transmissive absorbance At1 calculated by the paper-type determination processor 62B from the storage memory 50.

Next, the basis-weight calculator 64B calculates the basis weight of the sheet of paper P by applying the first reflective absorbance Ar1, the second reflective absorbance Ar2, and the first transmissive absorbance At1 in a basis-weight calculation formula that is derived in advance and stored in the storage memory 50.

The basis-weight calculation formula in the present embodiment is Equation (12) below.

Basis weight=C4+C5×Ar1+C6×Ar2+C7×At1 (12)

Here, coefficients C4 to C7 are coefficients determined according to conditions such as the wavelength of the light irradiated by the first illuminator 21, the paper type of the sheet of paper P, and the internal configuration of the copier 1C, and coefficients for various conditions are sought in advance by multiple regression analysis and stored in the storage memory 50.

As above, with the copier 1C in the present embodiment, the light that is irradiated from the first illuminator 21 and reflected or diffused by the sheet of paper P is received at different angles by the first photodetector 31 and the second photodetector 32. Moreover, the paper-type determination processor 62B, the moisture-content calculator 63B, and the basis-weight calculator 64B use these measurement results to respectively determine the paper type of the sheet of paper P, calculate the moisture content of the surface of the sheet of paper P, and calculate the basis weight of the sheet of paper P.

By this, the optical sensor 20C can more accurately acquire the information on the state of adhesion of the water molecules on the surface of the sheet of paper P and the information on the state of the water molecules inside the sheet of paper P. As a result, the paper-type determination processor 62B, the moisture-content calculator 63B, and the basis-weight calculator 64B can more precisely respectively determine and calculate the paper type of the sheet of paper P, the moisture content of the surface of the sheet of paper P, and the basis weight of the sheet of paper P. In particular, because the light reflected by the sheet of paper P includes the information on the state of adhesion of the water molecules on the surface of the sheet of paper P, a calculation precision of the moisture content of the surface of the sheet of paper P by the moisture-content calculator 63B can be improved.

Furthermore, with the optical sensor 20C in the present embodiment, the first illuminator 21 irradiates the light reflected or diffused by the sheet of paper P and the light transmitted through the sheet of paper P. By this, a number of illuminators in the optical sensor 20C can be made to be one; therefore, the configuration of the optical sensor 20C can be simplified.

### Embodiment 3

Another embodiment of the disclosure is described below. Note that for convenience in description, members having the same functions as members described in a previous embodiment are labeled with the same reference signs and description thereof is omitted.

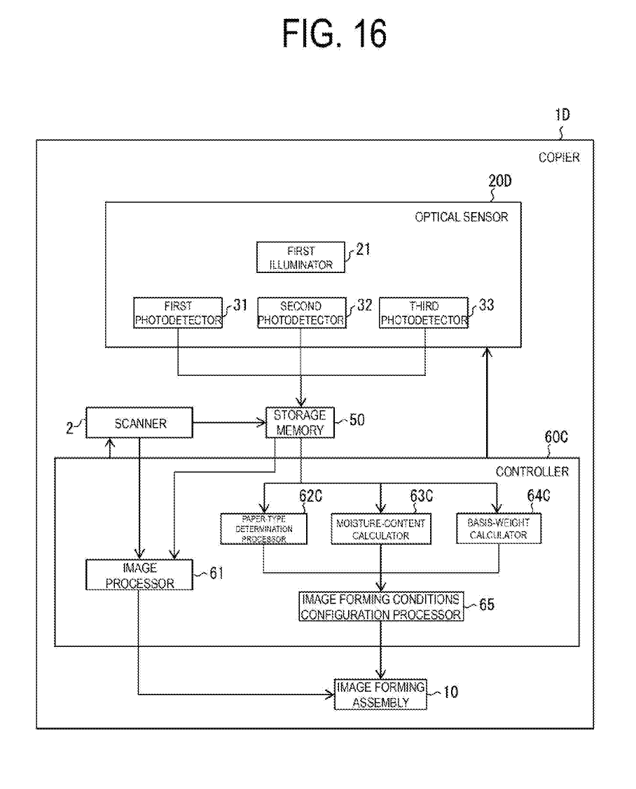

FIG. 16 is a block diagram illustrating a configuration of a main portion of a copier 1D in the present embodiment. As illustrated in FIG. 16, the copier 1D is provided with an optical sensor 20D and a controller 60C instead of the optical sensor 20A and the controller 60A in the copier 1A of Embodiment 1.

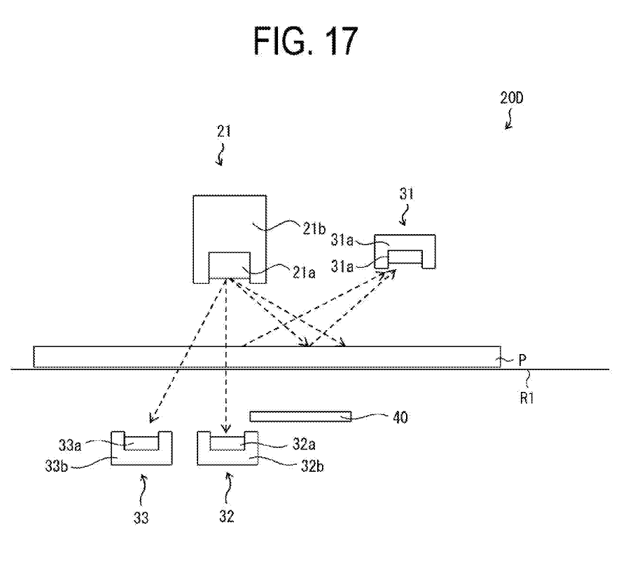

FIG. 17 is a schematic view illustrating a configuration of the optical sensor 20D. As illustrated in FIG. 16 and FIG. 17, the optical sensor 20D is provided with the first illuminator 21, the first photodetector (reflected-tight photodetector) 31, the second photodetector (first transmitted-light photodetector) 32, and the third photodetector (second transmitted-light photodetector) 33.

The first photodetector 31 is provided on the same side as the first illuminator 21 in relation to the main conveyance route R1. The first photodetector 31 receives the light that is irradiated from the first illuminator 21 and reflected or diffused by the sheet of paper P.

The second photodetector 32 is provided on the opposite side of the first illuminator 21 in relation to the main conveyance route R1. The second photodetector 32 receives the light that is irradiated from the first illuminator 21 and transmitted through the sheet of paper P.

The third photodetector 33 is provided on the opposite side of the first illuminator 21 in relation to the main conveyance route R1 and disposed lined up with the second photodetector 32 along the direction wherein the sheet of paper P is conveyed. The third photodetector 33 receives the light that is irradiated from the first illuminator 21 and transmitted through the sheet of paper P at an angle different from an angle whereat the second photodetector 32 receives the light.

The controller 60C is provided with a paper-type determination processor 62C, a moisture-content calculator 63C, and a basis-weight calculator 64C instead of the paper-type determination processor 62A, the moisture-content calculator 63A, and the basis-weight calculator 64A in the controller 60A of Embodiment 1.

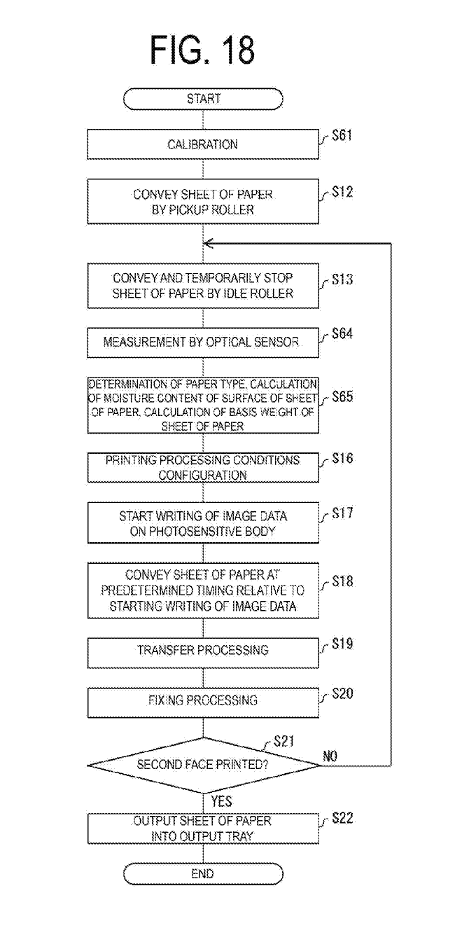

Next, printing processing (step S6 illustrated in FIG. 4) of the copier 1D is described with reference to FIG. 18. FIG. 18 is a flowchart illustrating one example of a flow of printing processing in the copier 1D.

As illustrated in FIG. 18, in printing processing (S6) on the sheet of paper P by the copier 1D, first, calibration is performed that acquires the reference data (S61).

Specifically, first, in a state where the sheet of paper P is not between the first illuminator 21 and the second photodetector 32 and the third photodetector 33, and the light source 21a of the first illuminator 21 is turned off, the first photodetector 31, the second photodetector 32, and the third photodetector 33 measure the intensity of the light (that is, the intensity of the background light). The first photodetector 31, the second photodetector 32, and the third photodetector 33 respectively output the electrical signal value Vb1, the electrical signal value Vb2, and the electrical signal value Vb3 of the sizes in accordance with the intensity of the measured light to the storage memory 50.

Next, the light source 21a of the first illuminator 21 is turned on and held standby for the predetermined time (millisecond units) until the emission state of the light source 21a stabilizes. Next, the first photodetector 31 receives a portion of the light that is irradiated from the light source 21a and reflected by the standard reflector 40 and outputs the electrical signal value Vr1 of the size in accordance with the intensity of the received light to the storage memory 50. Moreover, at the same time, the second photodetector 32 and the third photodetector 33 directly receive a portion of the light irradiated from the light source 21a and respectively output the electrical signal value Vr2 and the electrical signal value Vr3 of the sizes in accordance with the intensity of the received light to the storage memory 50.

Next, step S12 and step S13 are performed. Because step S12 and step S13 are similar to those in Embodiment 1, description thereof is omitted.

Next, the optical sensor 20D measures the sheet of paper P retained by the idle roller 5 (S64). Specifically, first, the light source 21a of the first illuminator 21 is turned on and held standby for the predetermined time (millisecond units) until the emission state of the light source 21a stabilizes. Next, the first photodetector 31 receives a portion of the light that is irradiated from the light source 21a and reflected or diffused by the sheet of paper P and outputs the electrical signal value Vp1 of the size in accordance with the intensity of the received light to the storage memory 50. Moreover, at the same time, the second photodetector 32 and the third photodetector 33 receive a portion of the light that is irradiated from the light source 21a and transmitted through the sheet of paper P and respectively output the electrical signal value Vp2 and the electrical signal value Vp3 of the sizes in accordance with the intensity of the received light to the storage memory 50.

Next, the paper-type determination processor 62C, the moisture-content calculator 63C, and the basis-weight calculator 64C respectively determine the paper type of the sheet of paper P, calculate the moisture content of the surface of the sheet of paper P, and calculate the basis weight of the sheet of paper P (S65). Details of each determination and calculation method are described below.

Because subsequent processing (steps S16 to S22) is similar to that in Embodiment 1, description thereof is omitted.

### Determination of Paper Type of Sheet of Paper P

Next, the determination method of the paper type of the sheet of paper P by e paper-type determination processor 62C is described.

First, the paper-type determination processor 62C calculates the first reflective absorbance Ar1 that is the absorbance of the light that is irradiated from the light source 21a, reflected or diffused by the sheet of paper P, and received by the first photodetector 31. Because the calculation method of the first transmissive absorbance At1 is similar to the calculation method described in Embodiment 1, description thereof is omitted.

Next, the paper-type determination processor 62C respectively calculates the first transmissive absorbance At1 and a second transmissive absorbance At2, which are absorbances of the light that is irradiated from the light source 21a, transmitted through the sheet of paper P, and received by the second photodetector 32 and the third photodetector 33. Because the calculation method of the first transmissive absorbance At1 and the second transmissive absorbance At2 is similar to the calculation method described in Embodiment 1, description thereof is omitted.

Next, the paper-type determination processor 62C determines the paper type of the sheet of paper P by applying the calculated first reflective absorbance Ar1, first transmissive absorbance At1, and second transmissive absorbance At2 in a paper-type-degree calculation formula that is derived in advance and stored in the storage memory

The paper-type-degree calculation formula in the present embodiment is Equation (13) below.

Paper-type degree=A8+A9×Ar1+A10×At1+A11×At2 (13)

Here, coefficients A8 to A11 are coefficients derived by canonical discriminant analysis based on data measured in advance by placing various paper types under various moisture-content conditions.

Next, the paper-type determination processor 62C determines the paper type of the sheet of paper P by determining which paper-type range the calculated paper-type degree is in.

### Calculation of Moisture Content of Sheet of Paper P

Next, the calculation method of the moisture content of the surface of the sheet of paper P by the moisture-content calculator 63C is described.

First, the moisture-content calculator 63C reads the first reflective absorbance Ar1, the first transmissive absorbance At1, and the second transmissive absorbance At2 calculated by the paper-type determination processor 62C from the storage memory 50.

Next, the moisture-content calculator 63C calculates the moisture content of the surface of the sheet of paper P by applying the first reflective absorbance Ar1, the first transmissive absorbance At1, and the second transmissive absorbance At2 in a moisture-content calculation formula that is derived in advance and stored in the storage memory 50.

The moisture-content calculation formula in the present embodiment is Equation (14) below.

Moisture content=B8+B9×Ar1+B10×At1+B11×At2 (14)

Here, coefficients B8 to B11 are coefficients determined according to conditions such as the wavelength of the light irradiated by the first illuminator 21, the paper type of the sheet of paper P, and the internal configuration of the copier 1D, and coefficients for various conditions are sought in advance by multiple regression analysis and stored in the storage memory 50.

### Calculation of Basis Weight of Sheet of Paper

Next, the calculation method of the basis weight of the sheet of paper P by the basis-weight calculator 64C is described.

First, the basis-weight calculator 64C reads the first reflective absorbance Ar1, the first transmissive absorbance At1, and the second transmissive absorbance At2 calculated by the paper-type determination processor 62C from the storage memory 50.

Next, the basis-weight calculator 64C calculates the basis weight of the sheet of paper P by applying the first reflective absorbance Ar1, the first transmissive absorbance At1, and the second transmissive absorbance At2 in a basis-weight calculation formula that is derived in advance and stored in the storage memory 50.

The basis-weight calculation formula the present embodiment is Equation (15) below.

Basis weight=C8+C9×Ar1+C10×At1+C11×At2 (15)

Here, coefficients C8 to C11 are coefficients determined according to conditions such as the wavelength of the light irradiated by the first illuminator 21, the paper type of the sheet of paper P, and the internal configuration of the copier 1D, and coefficients for various conditions are sought in advance by multiple regression analysis and stored in the storage memory 50.

Here, depending on the paper type of the sheet of paper P, the components thereof are complex and component amounts are also varied. For example, depending on the paper type, an additive is added to prevent ink from bleeding to the back side of the paper and prevent characters from being seen from the back, fine particles are added to improve strength, or a fluorescent agent is mixed in to whiten the sheet of paper and impart an image of high quality. Moreover, paper has a complex, multilayer structure where cellulose fibers are stacked in many layers. Because of this, using only an intensity of a light transmitted vertically through the sheet of paper P, information on essential characteristics of the paper, including complex components and fibers, cannot be sufficiently obtained, and precision of determining the paper type, calculating the moisture content of the surface, and calculating the basis weight may decrease.

In contrast, with the copier 1D in the present embodiment, the light that is irradiated from the first illuminator 21 and transmitted through the sheet of paper P at an angle that is not perpendicular is received by at least one from among the second photodetector 32 and the third photodetector 33 and the intensity of the received light is used to determine the paper type of the sheet of paper P, calculate the moisture content of the surface of the sheet of paper P, and calculate the basis weight of the sheet of paper P.

Light transmitted through the sheet of paper P at an angle that is not perpendicular is affected differently by a state of the components and the cellulose of the sheet of paper P than light transmitted through the sheet of paper P perpendicularly. Therefore, the optical sensor 20D can more accurately acquire information on the state of the components and the cellulose of the sheet of paper P. As a result, the paper-type determination processor 62C, the moisture-content calculator 63C, and the basis-weight calculator 64C can more precisely respectively determine and calculate the paper type of the sheet of paper P, the moisture content of the surface of the sheet of paper P, and the basis weight of the sheet of paper P.

Furthermore, with the optical sensor 20D in the present embodiment, the first illuminator 21 irradiates the light reflected or diffused by the sheet of paper P and the light transmitted through the sheet of paper P. By this, a number of illuminators in the optical sensor 20D can be made to be one; therefore, the configuration of the optical sensor 20D can be simplified.

### Embodiment 4

Another embodiment of the disclosure is described below. Note that for convenience in description, members having the same functions as members described in a previous embodiment are labeled with the same reference signs and description thereof is omitted.

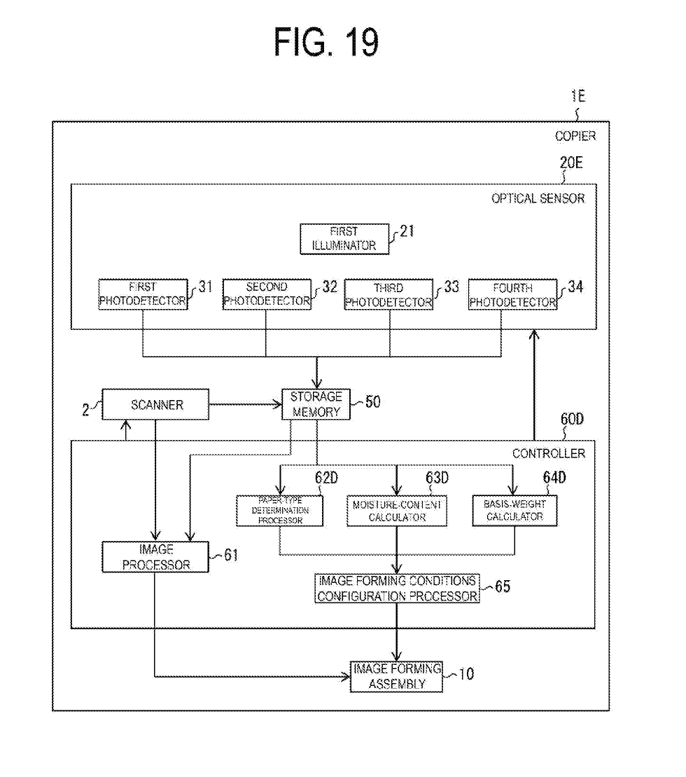

FIG. 19 is a block diagram illustrating a configuration of a main portion of a copier 1E in the present embodiment. As illustrated in FIG. 19, the copier 1E is provided with an optical sensor 20E and a controller 60D instead of the optical sensor 20A and the controller 60A in the copier 1A of Embodiment 1.

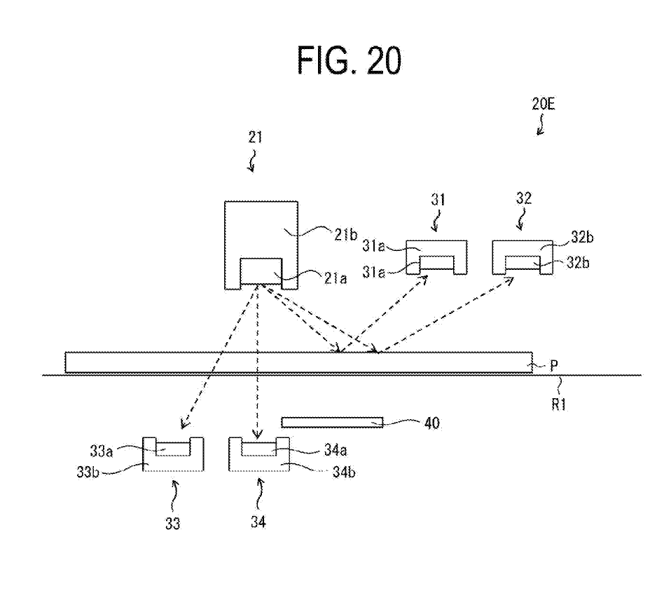

FIG. 20 is a schematic view illustrating a configuration of the optical sensor 20E. As illustrated in FIG. 19 and FIG. 20, the optical sensor 20E is provided with the first illuminator 21, the first photodetector 31 (first reflected-light photodetector), the second photodetector (second reflected-light photodetector) 32, the third photodetector (first transmitted-light photodetector) 33, and a fourth photodetector (second transmitted-light photodetector) 34.

The first photodetector 31 is provided on the same side as the first illuminator 21 in relation to the main conveyance route R1. The first photodetector 31 receives the light that is irradiated from the first illuminator 21 and reflected or diffused by the sheet of paper P.

The second photodetector 32 is provided on the same side as the first illuminator 21 in relation to the main conveyance route R1 and disposed lined up with the first photodetector 31 along the direction wherein the sheet of paper P is conveyed. The second photodetector 32 receives the light that is irradiated from the first illuminator 21 and reflected or diffused by the sheet of paper P at an angle different from the angle whereat the first photodetector 31 receives the light.

The third photodetector 33 is provided on the opposite side of the first illuminator 21 in relation to the main conveyance route R1. The third photodetector 33 receives the light that is irradiated from the first illuminator 21 and transmitted through the sheet of paper P.

The fourth photodetector 34 is provided on the opposite side of the first illuminator 21 in relation to the main conveyance route R1 and disposed lined up with the third photodetector 33 along the direction wherein the sheet of paper P is conveyed. The fourth photodetector 34 is provided with one light receiving device 34a and a housing 34b that houses the light receiving device 34a. Because a configuration of the fourth photodetector 34 is similar to the configuration of the first photodetector 31, description thereof is omitted. The fourth photodetector 34 receives the light that is irradiated from the first illuminator 21 and transmitted through the sheet of paper P at an angle different from the angle whereat the third photodetector 33 receives the light.

The controller 60D is provided with a paper-type determination processor 62D, a moisture-content calculator 63D, and a basis-weight calculator 64D instead of the paper-type determination processor 62A, the moisture-content calculator 63A, and the basis-weight calculator 64A in the controller 60A of Embodiment 1.

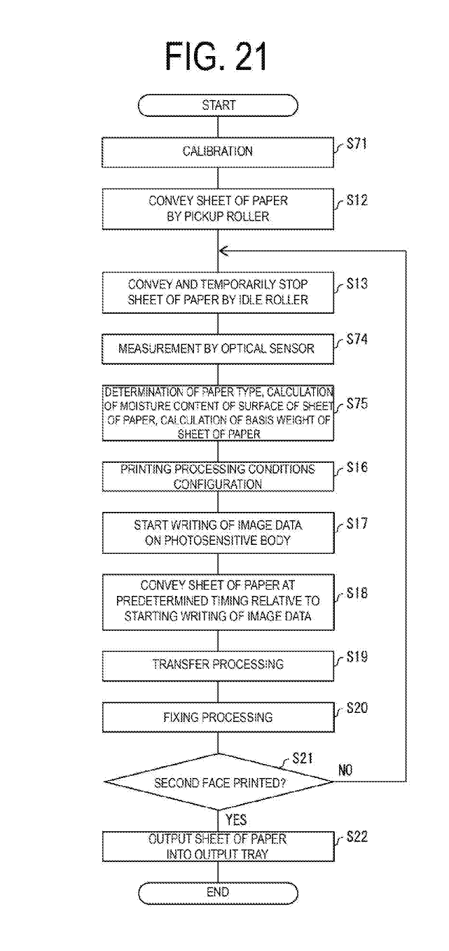

Next, printing processing (step S6 illustrated in FIG. 4) of the copier 1E is described with reference to FIG. 21. FIG. 21 is a flowchart illustrating one example of a flow of printing processing in the copier 1E.

As illustrated in FIG. 21, in printing processing (S6) on the sheet of paper P by the copier 1E, first, calibration is performed that acquires the reference data (S71).

Specifically, first, in a state where the sheet of paper P is not between the first illuminator 21 and the third photodetector 33 and the fourth photodetector 34, and the light source 21a of the first illuminator 21 is turned off, the first photodetector 31, the second photodetector 32, the third photodetector 33, and the fourth photodetector 34 measure the intensity of the light (that is, the intensity of the background light). The first photodetector 31, the second photodetector 32, the third photodetector 33, and the fourth photodetector 34 respectively output the electrical signal value Vb1, the electrical signal value Vb2, the electrical signal value Vb3, and an electrical signal value Vb4 of sizes in accordance with the intensity of the measured light.

Next, the light source 21a of the first illuminator 21 is turned on and held standby for the predetermined time (millisecond units) until the emission state of the light source 21a stabilizes. Next, the first photodetector 31 and the second photodetector 32 receive the light that is irradiated from the light source 21a and reflected by the standard reflector 40 and respectively output the electrical signal value Vr1 and the electrical signal value Vr2 of the sizes in accordance with the intensity of the received light to the storage memory 50. Moreover, at the same time, the third photodetector 33 and the fourth photodetector 34 directly receive a portion of the light irradiated from the light source 21a and respectively output the electrical signal value Vr3 and an electrical signal value Vr4 of sizes in accordance with the intensity of the received light to the storage memory 50.

Next, step S12 and step S13 are performed. Because step S12 and step S13 are similar to those in Embodiment 1, description thereof is omitted.

Next, the optical sensor 20E measures the sheet of paper P retained by the idle roller 5 (S74).

Specifically, first, the light source 21a of the first illuminator 21 is turned on and held standby for the predetermined time (millisecond units) until the emission state of the light source 21a stabilizes. Next, the first photodetector 31 and the second photodetector 32 receive the light that is irradiated from the light source 21a and reflected or diffused by the sheet of paper P and output the electrical signal value Vp1 and the electrical signal value Vp2 of the sizes in accordance with the intensity of the received light to the storage memory 50. Moreover, at the same time, the third photodetector 33 and the fourth photodetector 34 receive a portion of the light that is irradiated from the light source 21a and transmitted through the sheet of paper P and respectively output the electrical signal value Vp3 and the electrical signal value Vp4 of the sizes in accordance with the intensity of the received light to the storage memory 50.

Next, the paper-type determination processor 62D, the moisture-content calculator 63D, and the basis-weight calculator 64D respectively determine the paper type of the sheet of paper P, calculate the moisture content of the surface of the sheet of paper P, and calculate the basis weight of the sheet of paper P (S75). Details of each determination and calculation method are described below.

Because subsequent processing (steps S16 to S22) is similar to that in Embodiment 1, description thereof is omitted.

### Determination of Paper Type of Sheet of Paper P

Next, the determination method of the paper type of the sheet of paper P by the paper-type determination processor 62D is described.

First, the paper-type determination processor 62D calculates the first reflective absorbance Ar1 and a second reflective absorbance Ar2 that are the absorbances of the light that is irradiated from the light source 21a, reflected or diffused by the sheet of paper P, and received by the first photodetector 31 and the second photodetector 32. Because the calculation method of the first reflective absorbance Ar1 and the second reflective absorbance Ar2 is similar to the calculation method described in Embodiment 1, description thereof is omitted.

Next, the paper-type determination processor 62D respectively calculates the first transmissive absorbance At1 and the second transmissive absorbance At2 that are the absorbances of the light that is irradiated from the light source 21a, transmitted through the sheet of paper P, and received by the third photodetector 33 and the fourth photodetector 34. Because the calculation method of the first transmissive absorbance At1 and the second transmissive absorbance At2 are similar to the calculation method described in Embodiment 1, description thereof is omitted.

Next, the paper-type determination processor 62D determines the paper type of the sheet of paper P by applying the calculated first reflective absorbance Ar1, second reflective absorbance Ar2, first transmissive absorbance At1, and second transmissive absorbance At2 in a paper-type-degree calculation formula that is derived in advance and stored in the storage memory 50.

The paper-type-degree calculation formula in the present embodiment is Equation (16) below.

Paper-type degree=A12+A13×Ar1+A14×Ar2+A15×At1+A16×At2 (16)

Here, coefficients A12 to A16 are coefficients derived by canonical discriminant analysis based on data measured in advance by placing various paper types under various moisture-content conditions.

Next, the paper-type determination processor 62D determines the paper type of the sheet of paper P by determining which paper-type range the calculated paper-type degree is in.

### Calculation of Moisture Content of Sheet of Paper P

Next, the calculation method of the moisture content of the surface of the sheet of paper P by the moisture-content calculator 63D is described.

First, the moisture-content calculator 63D reads the first reflective absorbance Ar1, the second reflective absorbance Art, the first transmissive absorbance At1, and the second transmissive absorbance At2 calculated by the paper-type determination processor 62D from the storage memory 50.

Next, the moisture-content calculator 63D calculates the moisture content of the surface of the sheet of paper P by applying the first reflective absorbance Ar1, the second reflective absorbance Ar2, the first transmissive absorbance At1, and the second transmissive absorbance At2 in a moisture-content calculation formula that is derived in advance and stored in the storage memory 50.

The moisture-content calculation formula in the present embodiment is Equation (17) below.

Moisture content=B12+B13×Ar1+B14×Ar2+B15×At1+B16×At2 (17)

Here, coefficients B12 to B16 are coefficients determined according to conditions such as the wavelength of the light irradiated by the first illuminator 21, the paper type of the sheet of paper P, and the internal configuration of the copier 1E, and coefficients for various conditions are sought in advance by multiple regression analysis and stored in the storage memory 50.

### Calculation of Basis Weight of Sheet of Paper P

Next, the calculation method of the basis weight of the sheet of paper P by the basis-weight calculator 64D is described.

First, the basis-weight calculator 64D reads the first reflective absorbance Ar1, the second reflective absorbance Ar2, the first transmissive absorbance At1, and the second transmissive absorbance At2 calculated by the paper-type determination processor 62D from the storage memory 50.

Next, the basis-weight calculator 64D calculates the basis weight of the sheet of paper P by applying the first reflective absorbance Ar1, the second reflective absorbance Ar2, the first transmissive absorbance At1, and the second transmissive absorbance At2 in a basis-weight calculation formula that is derived in advance and stored in the storage memory 50.

The basis-weight calculation formula in the present embodiment is Equation (18) below.

Basis weight=C12+C13×Ar1+C14×Ar2+C15×At1+C16×At2 (18)

Here, coefficients C12 to C16 are coefficients determined according to conditions such as the wavelength of the light irradiated by the first illuminator 21, the paper type of the sheet of paper P, and the internal configuration of the copier 1E, and coefficients for various conditions are sought in advance by multiple regression analysis and stored in the storage memory 50.

As above, with the copier 1E in the present embodiment, the light that is irradiated from the first illuminator 21 and reflected or diffused by the sheet of paper P is received at different angles by the first photodetector 31 and the second photodetector 32. Moreover, the light that is irradiated from the first illuminator 21 and transmitted through the sheet of paper P is received at different angles by the third photodetector 33 and the fourth photodetector 34. Moreover, the paper-type determination processor 62D, the moisture-content calculator 63D, and the basis-weight calculator 64D use these measurement results to determine the paper type of the sheet of paper P, calculate the moisture content of the surface of the sheet of paper P, and calculate the basis weight of the sheet of paper P.

By this, the information on the state of adhesion of the water molecules on the surface of the sheet of paper P and the information on the state of the water molecules inside the sheet of paper P are accurately acquired and the information on the state of the components and the cellulose of the sheet of paper P is more accurately acquired. As a result, the paper-type determination processor 62D, the moisture-content calculator 63D, and the basis-weight calculator 64D can more precisely respectively determine and calculate the paper type of the sheet of paper P, the moisture content of the surface of the sheet of paper P, and the basis weight of the sheet of paper P.

Furthermore, with the optical sensor 20E in the present embodiment, the first illuminator 21 irradiates the light reflected or diffused by the sheet of paper P and the light transmitted through the sheet of paper P. By this, a number of illuminators in the optical sensor 20E can be made to be one; therefore, the configuration of the optical sensor 20E can be simplified.

### Embodiment 5

Another embodiment of the disclosure is described below. Note that for convenience in description, members having the same functions as members described in a previous embodiment are labeled with the same reference signs and description thereof is omitted.

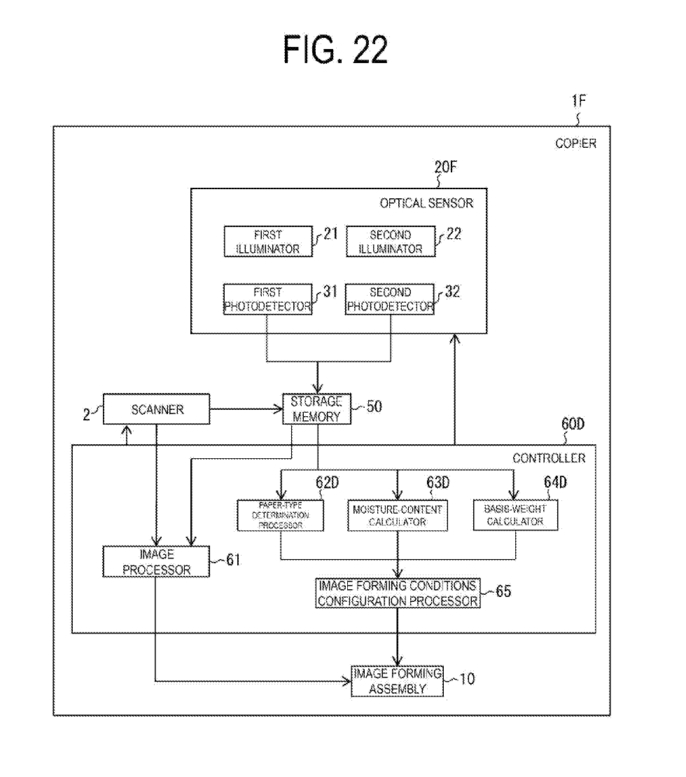

FIG. 22 is a block diagram illustrating a configuration of a main portion of a copier 1F in the present embodiment. As illustrated in FIG. 22, the copier 1F is provided with an optical sensor 20F instead of the optical sensor 20E in the copier 1E in Embodiment 4.

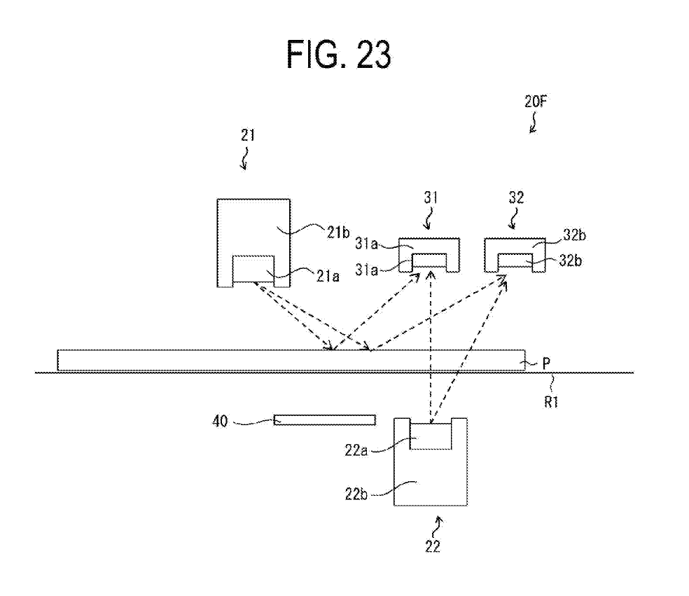

FIG. 23 is a schematic view illustrating a configuration of the optical sensor 20F. As illustrated in FIG. 22 and FIG. 23, the optical sensor 20F is provided with the first illuminator 21 (first illuminator), the second illuminator (second illuminator) 22, the first photodetector (first transmitted-light photodetector, first reflected-light photodetector) 31, and the second photodetector (second transmitted-light photodetector, second reflected-light photodetector) 32.

In the present embodiment, as illustrated in FIG. 23, the light irradiated from the first illuminator 21 is reflected or diffused by the sheet of paper P and received by the first photodetector 31 and the second photodetector 32.

The second illuminator 22 is provided on the opposite side of the first illuminator 21 in relation to the main conveyance route R1. The light irradiated from the second illuminator 22 is transmitted through the sheet of paper P and received by the first photodetector 31 and the second photodetector 32. The wavelength of the light irradiated by the light source 22a of the second illuminator 22 may be identical to or different from the wavelength of the light irradiated from the light source 21a of the first illuminator 21.

The first photodetector 31 is provided on the same side as the first illuminator 21 in relation to the main conveyance route R1. The first photodetector 31 receives a portion of the light that is irradiated from the first illuminator 21 and reflected or diffused by the sheet of paper P and a portion of the light that is irradiated from the second illuminator 22 and transmitted through the sheet of paper P.

The second photodetector 32 is provided on the same side as the first illuminator 21 in relation to the main conveyance route R1 and disposed lined up with the first photodetector 31 along the direction wherein the sheet of paper P is conveyed. The second photodetector 32 receives a portion of the light that is irradiated from the first illuminator 21 and reflected or diffused by the sheet of paper P at an angle different from the angle whereat the first photodetector 31 receives the light and receives a portion of the light that is irradiated from the second illuminator 22 and transmitted through the sheet of paper P at an angle different from an angle whereat the first photodetector 31 receives the light.

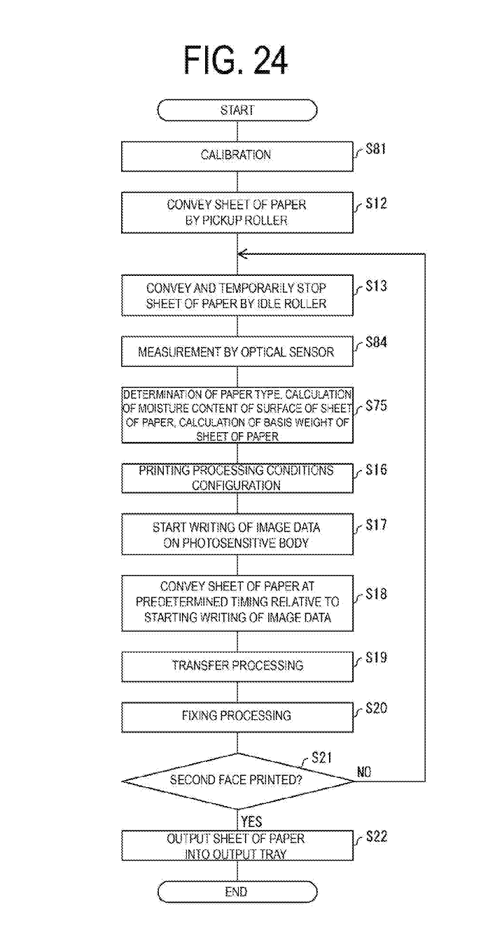

Next, printing processing (step S6 illustrated in FIG. 4) of the copier 1F is described with reference to FIG. 24. FIG. 24 is a flowchart illustrating one example of a flow of printing processing in the copier 1F.

As illustrated in FIG. 24, in printing processing (S6) on the sheet of paper P by the copier 1F, first, calibration is performed that acquires the reference data (S81).

Specifically, first, in a state where the sheet of paper P is not between the second illuminator 22 and the first photodetector 31 and the second photodetector 32, and the light source 21a of the first illuminator 21 and the light source 22a of the second illuminator 22 are turned off, the first photodetector 31 and the second photodetector 32 measure the intensity of the light (that is, the intensity of the background light). The first photodetector 31 and the second photodetector 32 respectively output the electrical signal value Vb1 and the electrical signal value Vb2 of the sizes in accordance with the intensity of the measured light.

Next, the light source 21a of the first illuminator 21 is turned on and held standby for the predetermined time (millisecond units) until the emission state of the light source 21a stabilizes. Next, the first photodetector 31 and the second photodetector 32 receive the light that is irradiated from the light source 21a and reflected by the standard reflector 40 and respectively output the electrical signal value Vr1 and the electrical signal value Vr2 of the sizes in accordance with the intensity of the received light to the storage memory 50.

Next, the light source 21a of the first illuminator 21 is turned off. Next, the light source 22a of the second illuminator 22 is turned on and held standby for the predetermined time (millisecond units) until the emission state of the light source 22a stabilizes. Next, the first photodetector 31 and the second photodetector 32 directly receive the light irradiated from the light source 22a and output the electrical signal value Vr3 and the electrical signal value Vr4 of the sizes in accordance with the intensity of the received light to the storage memory 50.

Next, step S12 and step S13 are performed. Because step S12 and step S13 are similar to those in Embodiment 1, description thereof is omitted.

Next, the optical sensor 20F measures the sheet of paper P retained by the idle roller 5 (S84). Specifically, first, the light source 21a of the first illuminator 21 is turned on and held standby for the predetermined time (millisecond units) until the emission state of the light source 21a stabilizes. Next, the first photodetector 31 and the second photodetector 32 receive the light that is irradiated from the light source 21a and reflected or diffused by the sheet of paper P and respectively output the electrical signal value Vp1 and the electrical signal value Vp2 of the sizes in accordance with the intensity of the received light to the storage memory 50.

Next, the light source 21a of the first illuminator 21 is turned off. Next, the light source 22a of the second illuminator 22 is turned on and held standby for the predetermined time (millisecond units) until the emission state of the light source 22a stabilizes. Next, the first photodetector 31 and the second photodetector 32 receive the light that is irradiated from the light source 22a and transmitted through the sheet of paper P and respectively output the electrical signal value Vp3 and an electrical signal value Vp4 of sizes in accordance with the intensity of the received light.

Because subsequent processing (step S75 and steps S16 to S22) is similar to Embodiment 4, description thereof is omitted.

As above, with the copier 1F in the present embodiment, the light that is irradiated from the first illuminator 21 and reflected or diffused by the sheet of paper P is received at different angles by the first photodetector 31 and the second photodetector 32. Moreover, the light that is irradiated from the second illuminator 22 and transmitted through the sheet of paper P is received at different angles by the first photodetector 31 and the second photodetector 32. Moreover, the paper-type determination processor 62D, the moisture-content calculator 63D, and the basis-weight calculator 64D use these measurement results to determine the paper type of the sheet of paper P, calculate the moisture content of the surface of the sheet of paper P, and calculate the basis weight of the sheet of paper P.

By this, the information on the state of adhesion of the water molecules on the surface of the sheet of paper P and the information on the state of the water molecules inside the sheet of paper P are accurately acquired and the information on the state of the components and the cellulose of the sheet of paper P is more accurately acquired. As a result, the paper-type determination processor 62D, the moisture-content calculator 63D, and the basis-weight calculator 64D can more precisely respectively determine and calculate the paper type of the sheet of paper P, the moisture content of the surface of the sheet of paper P, and the basis weight of the sheet of paper P.

Furthermore, with the optical sensor 20F in the present embodiment, the first photodetector 31 and the second photodetector 32 receive the light reflected or diffused by the sheet of paper P and the light transmitted through the sheet of paper P. By this, a number of photodetectors in the optical sensor 20F can be made to be two; therefore, the configuration of the optical sensor 20F can be simplified.

### Embodiment 6

Another embodiment of the disclosure is described below. Note that for convenience in description, members having the same functions as members described in a previous embodiment are labeled with the same reference signs and description thereof is omitted.

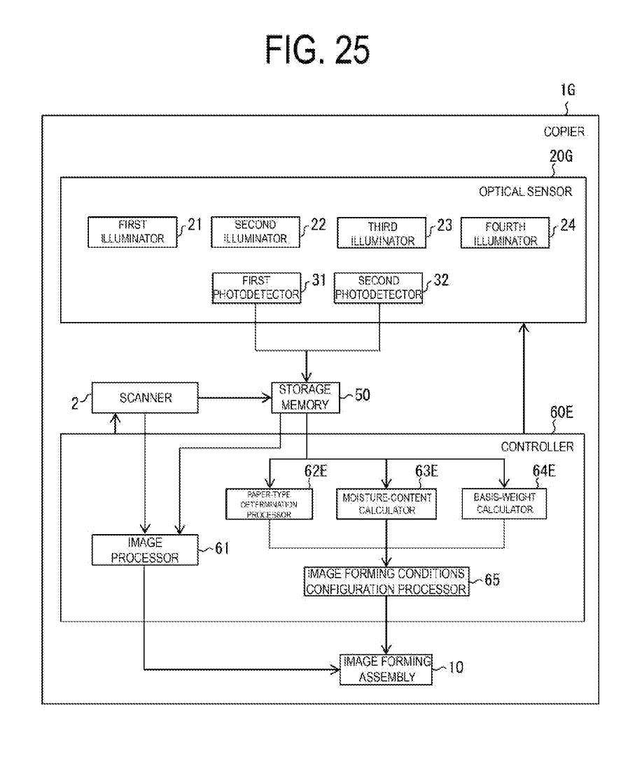

FIG. 25 is a block diagram illustrating a configuration of a main portion of a copier 1G in the present embodiment. As illustrated in FIG. 25, the copier 1G is provided with an optical sensor 20G and a controller 60E instead of the optical sensor 20A and the controller 60A in the copier 1A of Embodiment 1.

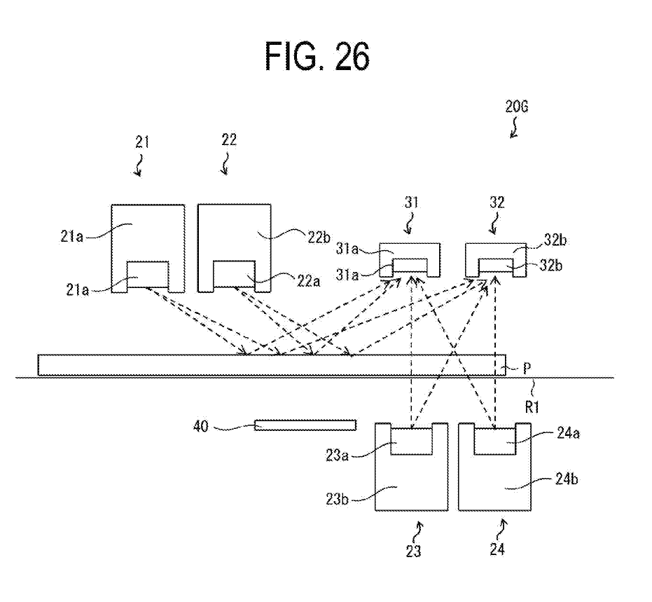

FIG. 26 is a schematic view illustrating a configuration of the optical sensor 20G. As illustrated in FIG. 25 and FIG. 26, the optical sensor 20G is provided with the first illuminator 21 (first illuminator), the second illuminator 22 (third illuminator), a third illuminator 23 (second illuminator), a fourth illuminator (fourth illuminator) 24, the first photodetector (first transmitted-light photodetector, first reflected-light photodetector) 31, and the second photodetector (second transmitted-light photodetector, second reflected-light photodetector) 32.

In the present embodiment, as illustrated in FIG. 26, the light irradiated from the first illuminator 21 is reflected or diffused by the sheet of paper P and received by the first photodetector 31 and the second photodetector 32.

The second illuminator 22 is provided on the same side as the first illuminator 21 in relation to the main conveyance route R1 and disposed lined up with the first illuminator 21 along the direction wherein the sheet of paper P is conveyed. The light irradiated from the second illuminator 22 is reflected or diffused by the sheet of paper P and received by the first photodetector 31 and the second photodetector 32. The wavelength of the light irradiated by the light source 22a of the second illuminator 22 is different from the wavelength of the light irradiated from the light source 21a of the first illuminator 21.

Note that in the present embodiment, the light source 21a of the first illuminator 21 and the light source 22a of the second illuminator 22 are semiconductor light-emitting elements but are not limited thereto. It is sufficient for the light source in one aspect of the disclosure to be a light source that can irradiate a light of a wavelength that enables calculation of the moisture content of the surface of the sheet of paper P and calculation of the basis weight of the sheet of paper P; for example, it may be a halogen lamp or a fluorescent body. When using the halogen lamp or the fluorescent body as the light source, a configuration may be adopted where the first illuminator 21 and the second illuminator 22 irradiate lights of different wavelengths by, for example, providing wavelength filters that transmit lights of different wavelengths to the light source of the first illuminator 21 and the light source of the second illuminator 22.

The third illuminator 23 is provided on the opposite side of the first illuminator 21 in relation to the main conveyance route R1. The third illuminator 23 is provided with one light source 23a and a housing 23b that houses the light source 23a. Because a configuration of the third illuminator 23 is similar to the configuration of the first illuminator 21, description is omitted. A light irradiated from the third illuminator 23 is transmitted through the sheet of paper P and received by the first photodetector 31 and the second photodetector 32. A wavelength of a light irradiated by the light source 23a of the third illuminator 23 is the same as the wavelength of the light irradiated by the light source 21a of the first illuminator 21.

The fourth illuminator 24 is provided on the opposite side of the first illuminator 21 in relation to the main conveyance route R1 and is disposed lined up with the third illuminator 23 along the direction wherein the sheet of paper P is conveyed. The fourth illuminator 24 is provided with one light source 24a and a housing 24b that houses the light source 24a. Because a configuration of the fourth illuminator 24 is similar to the configuration of the first illuminator 21, description thereof is omitted. A light irradiated from the fourth illuminator 24 is transmitted through the sheet of paper P and received by the first photodetector 31 and the second photodetector 32. A wavelength of a light irradiated by the light source 24a of the fourth illuminator 24 is the same as the wavelength of the light irradiated by the light source 22a of the second illuminator 22.

The first photodetector 31 is provided on the same side as the first illuminator 21 in relation to the main conveyance route R1. The first photodetector 31 receives the lights that are irradiated from the first illuminator 21 and the second illuminator 22 and. reflected or diffused by the sheet of paper P and the lights that are irradiated from the third illuminator 23 and the fourth illuminator 24 and transmitted through the sheet of paper P.

The second photodetector 32 is provided on the same side as the first illuminator 21 in relation to the main conveyance route R1 and disposed lined up with the first photodetector 31 along the direction wherein the sheet of paper P is conveyed. The second photodetector 32 receives the lights that are irradiated from the first illuminator 21 and the second illuminator 22 and reflected or diffused by the sheet of paper P at angles different from angles whereat the first photodetector 31 receives the lights and receives the lights that are irradiated from the third illuminator 23 and the fourth illuminator 24 and transmitted through the sheet of paper P at angles different from angles whereat the first photodetector 31 receives the lights.

The controller 60E is provided with a paper-type determination processor 62E, a moisture-content calculator 63E, and a basis-weight calculator 64E instead of the paper-type determination processor 62A, the moisture-content calculator 63A, and the basis-weight calculator 64A in the controller 60A of Embodiment 1.

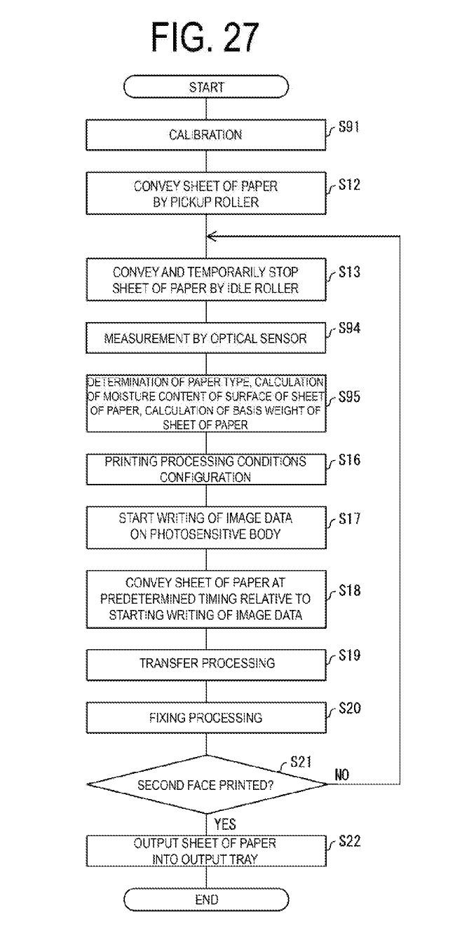

Next, printing processing (step S6 illustrated in FIG. 4) of the copier 1G is described with reference to FIG. 27. FIG. 27 is a flowchart illustrating one example of a flow of printing processing in the copier 1G.

As illustrated in FIG. 27, in printing processing (S6) on the sheet of paper P by the copier 1G, first, calibration is performed that acquires the reference data (S91).

Specifically, first, in a state where the sheet of paper P is not between the third illuminator 23 and the fourth illuminator 24 and the first photodetector 31 and the second photodetector 32, and the light source 21a of the first illuminator 21, the light source 22a of the second illuminator 22, the light source 23a of the third illuminator 23, and the light source 24a of the fourth illuminator 24 are turned off, the first photodetector 31 and the second photodetector 32 measure the intensity of the tight (that is, the intensity of the background light). The first photodetector 31 and the second photodetector 32 respectively output the electrical signal value Vb1 and the electrical signal value Vb2 of the sizes in accordance with the measured intensity of the light to the storage memory 50.

Next, the light source 21a of the first illuminator 21 is turned on and held standby the predetermined time (millisecond units) until the emission state of the light source 21a stabilizes. Next, the first photodetector 31 and the second photodetector 32 receive the light that is irradiated from the light source 21a and reflected by the standard reflector 40 and respectively output the electrical signal value Vr1 and the electrical signal value Vr2 of the sizes in accordance with the intensity of the received light to the storage memory 50.

Next, the light source 21a of the first illuminator 21 is turned off. Next, the light source 22a of the second illuminator 22 is turned on and held standby for the predetermined time (millisecond units) until the emission state of the light source 22a stabilizes. Next, the first photodetector 31 and the second photodetector 32 receive a light that is irradiated from the tight source 22a and reflected by the standard reflector 40 and respectively output the electrical signal value Vr3 and the electrical signal value Vr4 of sizes in accordance with an intensity of the received light to the storage memory 50.

Next, the light source 22a of the second illuminator 22 is turned off. Next, the light source 23a of the third illuminator 23 is turned on and held standby for a predetermined time (millisecond units) until an emission state of the light source 23a stabilizes. Next, the first photodetector 31 and the second photodetector 32 directly receive a portion of the light irradiated from the light source 23a and output an electrical signal value Vr5 and an electrical signal value Vr6 of sizes in accordance with an intensity of the received light to the storage memory 50.

Next, the light source 23a of the third illuminator 23 is turned off. Next, the light source 24a of the fourth illuminator 24 is turned on and held standby for a predetermined time (millisecond units) until an emission state of the light source 24a stabilizes. Next, the first photodetector 31 and the second photodetector 32 directly receive a portion of the light irradiated from the light source 24a and output an electrical signal value Vr7 and an electrical signal value Vr8 of sizes in accordance with an intensity of the received light to the storage memory 50.

Next, step S12 and step S13 are performed. Because step S12 and step S13 are similar to those in Embodiment 1, description thereof is omitted.

Next, the optical sensor 20G measures the sheet of paper P retained by the idle roller 5 (S94).

Specifically, first, the light source 21a of the first illuminator 21 is turned on and held standby for the predetermined time (millisecond units) until the emission state of the light source 21a stabilizes. Next, the first photodetector 31 and the second photodetector 32 receive the light that is irradiated from the light source 21a and reflected or diffused by the sheet of paper P and respectively output the electrical signal value Vp1 and the electrical signal value Vp2 of the sizes in accordance with the intensity of the received light to the storage memory 50.

Next, the light source 21a of the first illuminator 21 is turned off. Next, the light source 22a of the second illuminator 22 is turned on and held standby for the predetermined time (millisecond units) until the emission state of the light source 22a stabilizes. Next, the first photodetector 31 and the second photodetector 32 receive the light that is irradiated from the light source 22a and reflected or diffused by the sheet of paper P and output the electrical signal value Vp3 and the electrical signal value Vp4 of the sizes in accordance with the intensity of the received light to the storage memory 50.

Next, the light source 22a of the second illuminator 22 is turned off. Next, the light source 23a of the third illuminator 23 is turned on and held standby for the predetermined time (millisecond units) until the emission state of the light source 23a stabilizes. Next, the first photodetector 31 and the second photodetector 32 receive the light that is irradiated from the light source 23a and transmitted through the sheet of paper P and output an electrical signal value Vp5 and an electrical signal value Vp6 of sizes in accordance with the intensity of the received tight to the storage memory 50.

Next, the light source 23a of the third illuminator 23 is turned off. Next, the light source 24a of the fourth illuminator 24 is turned on and held standby for the predetermined time (millisecond units) until the emission state of the light source 24a stabilizes. Next, the first photodetector 31 and the second photodetector 32 receive the light that is irradiated from the light source 24a and transmitted through the sheet of paper P and output an electrical signal value Vp7 and an electrical signal value Vp8 of sizes in accordance with the intensity of the received light to the storage memory 50.

Next, the paper-type determination processor 62E, the moisture-content calculator 63E, and the basis-weight calculator 64E respectively determine the paper type of the sheet of paper P, calculate the moisture content of the surface of the sheet of paper P, and calculate the basis weight of the sheet of paper P (S95). Details of each determination and calculation method are described below.

Because subsequent processing (steps S16 to S22) is similar to that in Embodiment 1, description thereof is omitted.

### Determination of Paper Type of Sheet of Paper P

Next, the determination method of the paper type of the sheet of paper P by the paper-type determination processor 62E is described.

First, the paper-type determination processor 62E calculates the first reflective absorbance Ar1 and the second reflective absorbance Ar2 that are the absorbances of the light that is irradiated from the light source 21a, reflected or diffused by the sheet of paper P, and received by the first photodetector 31 and the second photodetector 32. Next, the paper-type determination processor 62E calculates a third reflective absorbance Ar3 and a fourth reflective absorbance Ar4 that are absorbances of the light that is irradiated from the light source 22a, reflected or diffused by the sheet of paper P, and received by the first photodetector 31 and the second photodetector 32. Because the calculation method of the first reflective absorbance Ar1, the second reflective absorbance Ar2, the third reflective absorbance Ar3, and the fourth reflective absorbance Ar4 is similar to the calculation method described in Embodiment 1, description thereof is omitted.

Next, the paper-type determination processor 62E respectively calculates the first transmissive absorbance At1 and the second transmissive absorbance At2 that are the absorbances of the light that is irradiated from the light source 23a, transmitted through the sheet of paper P, and received by the first photodetector 31 and the second photodetector 32. Next, the paper-type determination processor 62E respectively calculates a third transmissive absorbance At3 and a fourth transmissive absorbance At4, which are absorbances of the light that is irradiated from the light source 24a, transmitted through the sheet of paper P, and received by the first photodetector 31 and the second photodetector 32. Because the calculation method of the first transmissive absorbance At1, the second transmissive absorbance At2, the third transmissive absorbance At3, and the fourth transmissive absorbance At4 is similar to the calculation method described in Embodiment 1, description thereof is omitted.

Next, the paper-type determination processor 62E determines the paper type of the sheet of paper P by applying each calculated absorbance in a paper-type-degree calculation formula that is derived in advance and stored in the storage memory 50.

The paper-type-degree calculation formula in the present embodiment is Equation (19) below.

Paper-type degree=A17+A18×Ar1+A19×Ar2+A20×Ar3+A21×Ar4+A22×At1+A23×At2+A24×At3+A25×At4 (19)

Here, coefficients A17 to A25 are coefficients derived by canonical discriminant analysis based on data measured in advance by placing various paper types under various moisture-content conditions.

Next, the paper-type determination processor 62E determines the paper type of the sheet of paper P by determining which paper-type range the calculated paper-type degree is in.

### Calculation of Moisture Content of Sheet of Paper P

Next, the calculation method of the moisture content of the surface of the sheet of paper P by the moisture-content calculator 63E is described.

First, the moisture-content calculator 63E reads the first reflective absorbance Ar1, the second reflective absorbance Ar2, the third reflective absorbance Ar3, the fourth reflective absorbance Ar4, the first transmissive absorbance At1, the second transmissive absorbance At2, the third transmissive absorbance At3, and the fourth transmissive absorbance At4 from the storage memory 50.

Next, the moisture-content calculator 63D calculates the moisture content of the surface of the sheet of paper P by applying each absorbance in a moisture-content calculation formula that is derived in advance and stored in the storage memory 50.

The moisture-content calculation formula in the present embodiment is Equation (20) below.

Moisture content=B17+B18×Ar1+B19×Ar2+B20×Ar3+B21×Ar4+B22×At1+B23×At2+B24×At3+B25×At4 (20)

Here, coefficients B17 to B25 are coefficients determined in accordance with conditions such as the wavelengths of the lights respectively irradiated by the first illuminator 21, the second illuminator 22, the third illuminator 23, and the fourth illuminator 24; the paper type of the sheet of paper P; the internal configuration of the copier 1G; and the like, and the coefficients according to these conditions are sought in advance by multiple regression analysis and stored in the storage memory 50.

### Calculation of Basis Weight of Sheet of Paper

Next, the calculation method of the basis weight of the sheet of paper P by the basis-weight calculator 64E is described.

First, the basis-weight calculator 64E reads the first reflective absorbance Ar1, the second reflective absorbance Ar2, the third reflective absorbance Ar3, the fourth reflective absorbance Ar4, the first transmissive absorbance At1, the second transmissive absorbance At2, the third transmissive absorbance At3, and the fourth transmissive absorbance At4 from the storage memory 50.

Next, the basis-weight calculator 64D calculates the basis weight of the sheet of paper P by applying each absorbance in a basis-weight calculation formula that is derived in advance and stored in the storage memory 50.

The basis-weight calculation formula in the present embodiment is Equation (21) below.

Basis weight=C17+C18×Ar1+C19×Ar2+C20×Ar3+C21×Ar4+C22×At1+C23×At2+C24×At3+C25×At4 (21)

Here, coefficients C17 to C25 are coefficients determined in accordance with conditions such as the wavelengths of the lights respectively irradiated by the first illuminator 21, the second illuminator 22, the third illuminator 23, and the fourth illuminator 24; the paper type of the sheet of paper P; the internal configuration of the copier 1G; and the like, and the coefficients according to these conditions are sought in advance by multiple regression analysis and stored in the storage memory 50.

As above, with the copier IC in the present embodiment, the lights of the different wavelengths irradiated by the first illuminator 21 and the second illuminator 22 are reflected or diffused by the sheet of paper P and received by the first photodetector 31 and the second photodetector 32. Moreover, using the intensities of the received lights, the paper-type determination processor 62E, the moisture-content calculator 63E, and the basis-weight calculator 64E respectively determine the paper type of the sheet of paper P, calculate the moisture content of the surface of the sheet of paper P, and calculate the basis weight of the sheet of paper P.

Here, it is known that depending on the paper type of the sheet of paper P, behaviors of reflection and diffusion differ according to the state of the water molecules of the surface of the sheet of paper P, the state of the cellulose fibers, and the wavelength of the irradiated light. Therefore, by having the configuration above, the copier 1G can acquire more information on the state of the water molecules of the surface of the sheet of paper P and the state of the cellulose fibers. As a result, the paper-type determination processor 62E, the moisture-content calculator 63E, and the basis-weight calculator 64E can precisely determine the paper type of the sheet of paper P, calculate the moisture content of the surface of the sheet of paper P, and calculate the basis weight of the sheet of paper P.

Furthermore, with the copier 1G in the present embodiment, the lights of the different wavelengths irradiated by the third illuminator 23 and the fourth illuminator 24 are transmitted through the sheet of paper P and received by the first photodetector 31 and the second photodetector 32. Moreover, using the intensities of the received lights, the paper-type determination processor 62E, the moisture-content calculator 63E, and the basis-weight calculator 64E respectively determine the paper type of the sheet of paper P, calculate the moisture content of the surface of the sheet of paper P, and calculate the basis weight of the sheet of paper P.

Here, it is known that depending on the paper type of the sheet of paper P, a behavior of transmission differs according to the state of the components and the cellulose fibers and the wavelength of the irradiated light. Therefore, by having the configuration above, the copier 1G can acquire more information on the state of the components and the cellulose fibers of the sheet of paper P. As a result, the paper-type determination processor 62E, the moisture-content calculator 63E, and the basis-weight calculator 64E can precisely determine the paper type of the sheet of paper P, calculate the moisture content of the surface of the sheet of paper P, and calculate the basis weight of the sheet of paper P.

Furthermore, with the optical sensor 20G in the present embodiment, the first photodetector 31 and the second photodetector 32 receive the light reflected or diffused by the sheet of paper P and the light transmitted through the sheet of paper P. By this, a number of photodetectors in the optical sensor 20G can be made to be two (that is, there is no need to provide four photodetectors); therefore, the configuration of the optical sensor 20F can be simplified.

### Embodiment 7

Another embodiment of the disclosure is described below. Note that for convenience in description, members having the same functions as members described in a previous embodiment are labeled with the same reference signs and description thereof is omitted.

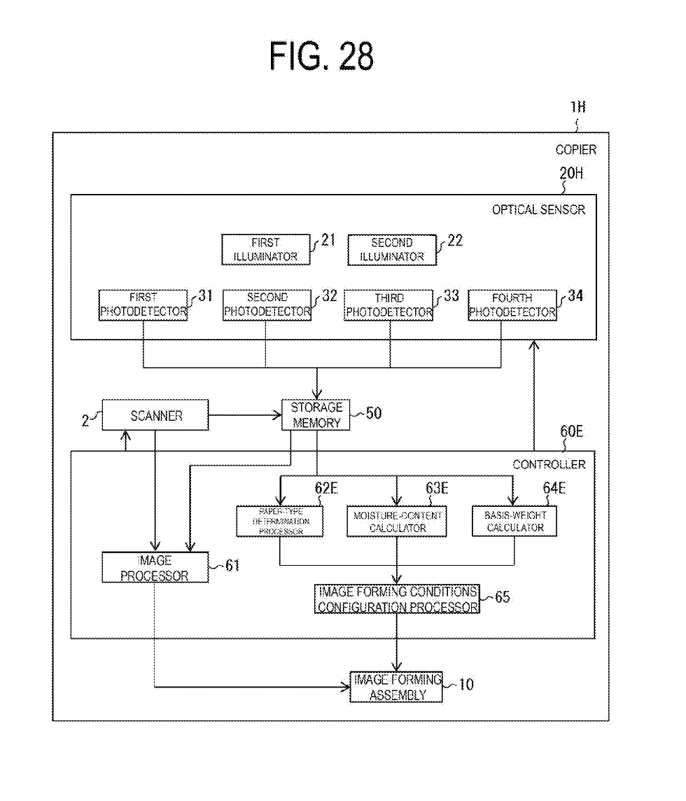

FIG. 28 is a block diagram illustrating a configuration of a main portion of a copier 1H in the present embodiment. As illustrated in FIG. 28, the copier 1H is provided with an optical sensor 20H instead of the optical sensor 20G in the copier 1G of Embodiment 6.

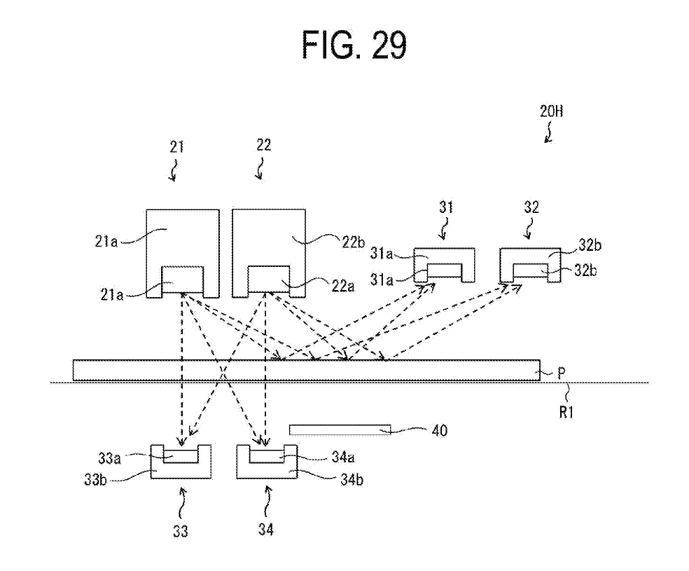

FIG. 29 is a schematic view illustrating a configuration of the optical sensor 20H. As illustrated in FIG. 28 and FIG. 29, the optical sensor 20H is provided with the first illuminator 21, the second illuminator 22, the first photodetector 31 (first reflected-light photodetector), the second photodetector (second reflected-light photodetector) 32, the third photodetector (first transmitted-light photodetector) 33, and the fourth photodetector (second transmitted-light photodetector) 34.

In the present embodiment, as illustrated in FIG. 29, a portion of the light irradiated from the first illuminator 21 is reflected or diffused by the sheet of paper P and received by the first photodetector 31 and the second photodetector 32. Moreover, another portion of the light irradiated from the first illuminator 21 is transmitted through the sheet of paper P and received by the third photodetector 33 and the fourth photodetector 34.

The second illuminator 22 is provided on the same side as the first illuminator 21 in relation to the main conveyance route R1 and disposed lined up with the first illuminator 21 along the direction wherein the sheet of paper P is conveyed. A portion of the light irradiated from the second illuminator 22 is reflected or diffused by the sheet of paper P and received by the first photodetector 31 and the second photodetector 32. Moreover, another portion of the light irradiated from the second illuminator 22 is transmitted through the sheet of paper P and received by the third photodetector 33 and the fourth photodetector 34. The wavelength of the light irradiated by the light source 22a of the second illuminator 22 is different from the wavelength of the light irradiated from the light source 21a of the first illuminator 21.

The first photodetector 31 is provided on the same side as the first illuminator 21 in relation to the main conveyance route R1. The first photodetector 31 receives the lights that are irradiated from the first illuminator 21 and the second illuminator 22 and reflected or diffused by the sheet of paper P.

The second photodetector 32 is provided on the same side as the first illuminator 21 in relation to the main conveyance route R1 and disposed lined up with the first photodetector 31 along the direction wherein the sheet of paper P is conveyed. The second photodetector 32 receives the lights that are irradiated from the first illuminator 21 and the second illuminator 22 and reflected or diffused by the sheet of paper P at angles different from angles whereat the first photodetector 31 receives the lights.

The third photodetector 33 is provided on the opposite side of the first illuminator in relation to the main conveyance route R1. The third photodetector 33 receives the lights that are irradiated from the first illuminator 21 and the second illuminator 22 and transmitted through the sheet of paper P.

The fourth photodetector 34 is provided on the opposite side of the first illuminator 21 in relation to the main conveyance route R1 and disposed lined up with the third photodetector 33 along the direction wherein the sheet of paper P is conveyed. The fourth photodetector 34 receives the lights that are irradiated from the first illuminator 21 and the second illuminator 22 and transmitted through the sheet of paper P at angles different from angles whereat the third photodetector 33 receives the lights.

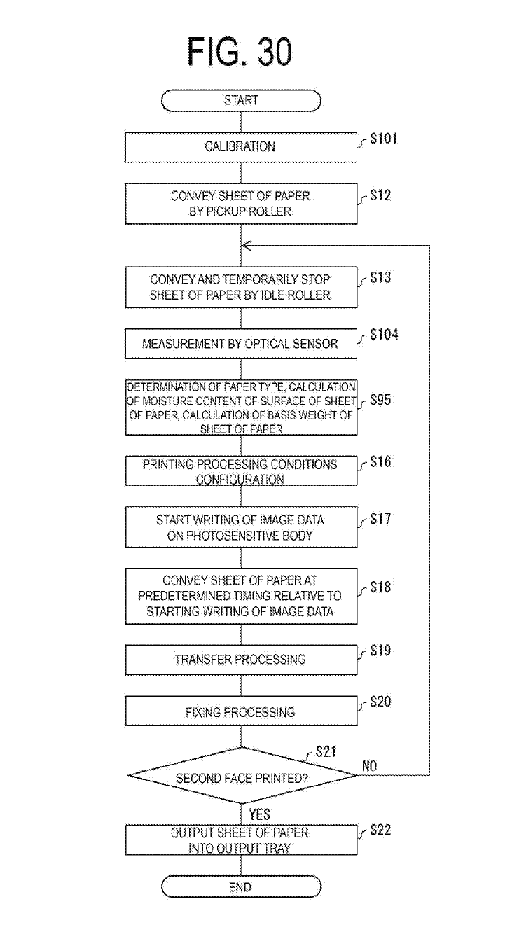

Next, printing processing (step S6 illustrated in FIG. 4) of the copier 1H is described with reference to FIG. 30. FIG. 30 is a flowchart illustrating one example of a flow of printing processing in the copier 1H.

As illustrated in FIG. 30, in printing processing (S6) on the sheet of paper P by the copier 1E, first, calibration is performed that acquires the reference data (S101).

Specifically, first, in a state where the sheet of paper P is not between the first illuminator 21 and the second illuminator 22 and the third photodetector 33 and the fourth photodetector 34, and the light source 21a of the first illuminator 21 and the light source 22a of the second illuminator 22 are turned off, the first photodetector 31, the second photodetector 32, the third photodetector 33, and the fourth photodetector 34 measure the intensity of the light (that is, the intensity of the background light). The first photodetector 31, the second photodetector 32, the third photodetector 33, and the fourth photodetector 34 respectively output the electrical signal value Vb1, the electrical signal value Vb2, the electrical signal value Vb3, and the electrical signal value Vb4 of the sizes in accordance with the intensity of the measured light.

Next, the light source 21a of the first illuminator 21 is turned on and held standby for the predetermined time (millisecond units) until the emission state of the light source 21a stabilizes. Next, the first photodetector 31 and the second photodetector 32 receive the light that is irradiated from the light source 21a and reflected by the standard reflector 40 and respectively output the electrical signal value Vr1 and the electrical signal value Vr2 of the sizes in accordance with the intensity of the received light to the storage memory 50. Moreover, at the same time, the third photodetector 33 and the fourth photodetector 34 directly receive a portion of the light irradiated from the light source 21a and respectively output the electrical signal value Vr3 and the electrical signal value Vr4 of the sizes in accordance with the intensity of the received light to the storage memory 50.

Next, the light source 21a of the first illuminator 21 is turned off. Next, the light source 22a of the second illuminator 22 is turned on and held standby for the predetermined time (millisecond units) until the emission state of the light source 22a stabilizes. Next, the first photodetector 31 and the second photodetector 32 receive the light that is irradiated from the light source 22a and reflected by the standard reflector 40 and respectively output the electrical signal value Vr5 and the electrical signal value Vr6 of the sizes in accordance with the intensity of the received light to the storage memory 50. Moreover, at the same time, the third photodetector 33 and the fourth photodetector 34 directly receive a portion of the light irradiated from the light source 22a and respectively output the electrical signal value Vr7 and the electrical signal value Vr8 of the sizes in accordance with the intensity of the received light to the storage memory 50.

Next, step S12 and step S13 are performed. Because step S12 and step S13 are similar to those in Embodiment 1, description thereof is omitted.

Next, the optical sensor 20H measures the sheet of paper P retained by the idle roller 5 (S104).

Specifically, first, the light source 21a of the first illuminator 21 is turned on and held standby for the predetermined time (millisecond units) until the emission state of the light source 21a stabilizes. Next, the first photodetector 31 and the second photodetector 32 receive the light that is irradiated from the light source 21a and reflected or diffused by the sheet of paper P and output the electrical signal value Vp1 and the electrical signal value Vp2 of the sizes in accordance with the intensity of the received light to the storage memory 50. Moreover, at the same time, the third photodetector 33 and the fourth photodetector 34 respectively output the electrical signal value Vp3 and the electrical signal value Vp4 of the sizes in accordance with the intensity of the light that is irradiated from the light source 21a and transmitted through the sheet of paper P to the storage memory 50.

Next, the light source 21a of the first illuminator 21 is turned off. Next, the light source 22a of the second illuminator 22 is turned on and held standby for the predetermined time (millisecond units) until the emission state of the light source 22a stabilizes. Next, the first photodetector 31 and the second photodetector 32 receive the light that is irradiated from the light source 22a and reflected or diffused by the sheet of paper P and output the electrical signal value Vp5 and the electrical signal value Vp6 of the sizes in accordance with the intensity of the received light to the storage memory 50. Moreover, at the same time, the third photodetector 33 and the fourth photodetector 34 respectively output the electrical signal value Vp7 and the electrical signal value Vp8 of the sizes in accordance with the intensity of the light that is irradiated from the light source 22a and transmitted through the sheet of paper P to the storage memory 50.

Because subsequent processing (step S95 and steps S16 to S22) is similar to Embodiment 5, description thereof is omitted.

As above, with the copier 1H in the present embodiment, the lights of the different wavelengths irradiated by the first illuminator 21 and the second illuminator 22 are reflected or diffused by the sheet of paper P and received by the first photodetector 31 and the second photodetector 32. Moreover, the lights of the different wavelengths irradiated by the first illuminator 21 and the second illuminator 22 are transmitted through the sheet of paper P and received by the third photodetector 33 and the fourth photodetector 34. Moreover, using the intensities of the received lights, the paper-type determination processor 62E, the moisture-content calculator 63E, and the basis-weight calculator 64E respectively determine the paper type of the sheet of paper P, calculate the moisture content of the surface of the sheet of paper P, and calculate the basis weight of the sheet of paper P. Therefore, exhibited are effects similar to those in Embodiment 6.

Furthermore, with the optical sensor 20H in the present embodiment, the first illuminator 21 and the second illuminator 22 irradiate the light reflected or diffused by the sheet of paper P and the light transmitted through the sheet of paper P. By this, a number of illuminators in the optical sensor 20H can be made to be two (that is, there is no need to provide four illuminators); therefore, the configuration of the optical sensor 20F can be simplified.

### Embodiment 8

Another embodiment of the disclosure is described below. Note that for convenience in description, members having the same functions as members described in a previous embodiment are labeled with the same reference signs and description thereof is omitted.

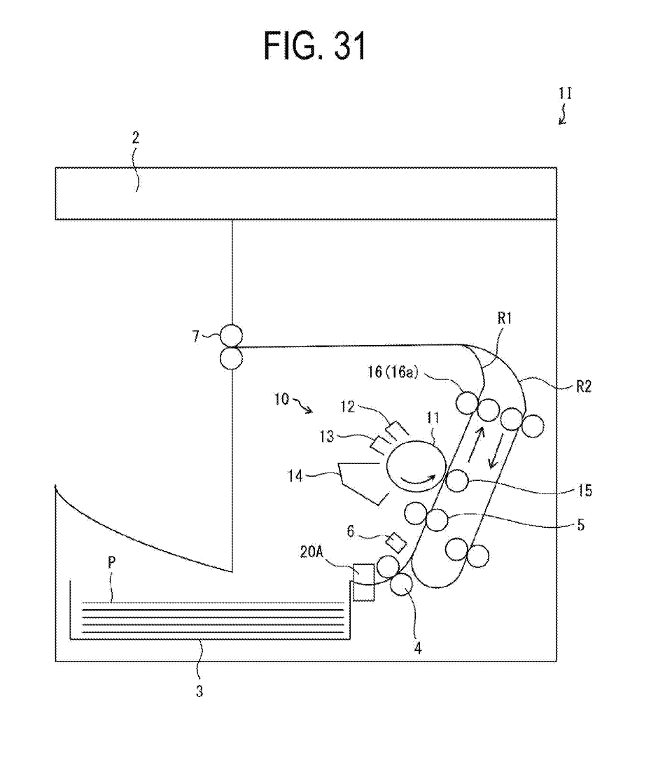

FIG. 31 is a schematic view illustrating a structure of a copier 1I.

As illustrated in FIG. 31, with the copier 1I, a position wherein the optical sensor 20A is disposed is different from the position wherein the optical sensor 20A in the copier 1A in Embodiment 1 is disposed.

In the present embodiment, the optical sensor 20A is disposed on the main conveyance route R1 between the paper feed cassette 3 and the pickup roller 4.

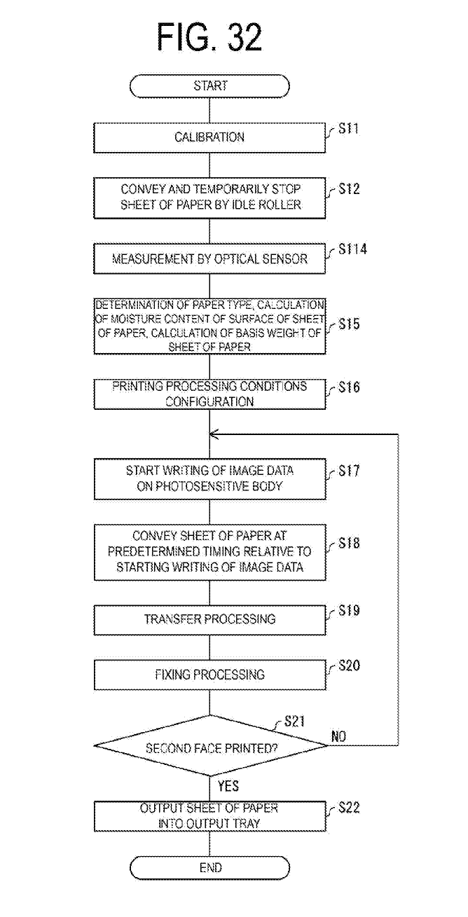

Next, printing processing (step S6 illustrated in FIG. 4) of the copier 1I is described with reference to FIG. 32. FIG. 32 is a flowchart illustrating one example of a flow of printing processing in the copier 1I.

As illustrated in FIG. 32, in printing processing (S6) on the sheet of paper P by the copier 1I, first, step S11 and step S12 are performed. Because step S11 and step S12 are similar to step S11 and step S12 in Embodiment 1, description thereof is omitted.

Next, the optical sensor 20A measures one sheet of paper P extracted from the paper feed cassette 3 by the pickup roller 4 (S114). Because specific measurement is similar to that at step S14 in Embodiment 1, description thereof is omitted.

Because subsequent processing (steps S15 to S20 and step S22) is similar to Embodiment 1, description thereof is omitted.

As above, with the copier 1I in the present embodiment, the optical sensor 20A measures the sheet of paper P while the sheet of paper P is being extracted from the paper feed cassette 3 by the pickup roller 4. By this, configuration of the image forming conditions by the image forming conditions configuration processor 65 can be performed quickly; therefore, time required for printing can be shortened. For example, because unlike a current a fixing temperature cannot be changed quickly, more favorable printing can be realized by speeding up measurement by the optical sensor 20A and creating a time margin. Moreover, because conditions of each roller such as a conveyance speed can be configured in advance, an effect is obtained where, for example, errors where the sheet of paper P becomes jammed in the idle roller 5 can be decreased.

Furthermore, because a need is eliminated of stopping conveyance of the sheet of paper P for measurement by the optical sensor 20A, time required for printing can be further decreased.

Furthermore, because the optical sensor 20A irradiates the light to the sheet of paper P that is being conveyed, the optical sensor 20A can irradiate the light in a range from an end to a center of the sheet of paper P. As a result, even in a case where there is a distribution of moisture or thickness in the sheet of paper P, data can be obtained where bias in this distribution is averaged; therefore, determination of the paper type of the sheet of paper P and calculation of the basis weight and the moisture content of the sheet of paper P can be precisely performed.

Note that another optical sensor may be provided before the idle roller 5 (in the position where the optical sensor 20A is disposed in Embodiment 1). By this, in a situation in printing the first face of the sheet of paper P where the sheet of paper P is heated by the pressure roller 16a, the moisture of the sheet of paper P evaporates, and a discrepancy arises with the moisture content measured by the optical sensor 20A, the printing conditions for the second face of the sheet of paper P can be suitably adjusted by measuring the sheet of paper P again by the other optical sensor.

### Implementation Example by Software

Control blocks (in particular, controllers 60A to 60E) of the copiers 1A to 1I may be realized by logic circuits (hardware) formed on integrated circuits (IC chips) or the like or realized by software using CPUs (central processing units).

In the latter case, the copiers 1A to 1I are provided with a CPU that executes a command of a program that is software that realizes each function, a ROM (read-only memory) or a storage device (collectively, “recording medium”) where the program above and various data are recorded in a manner readable by a computer (or the CPU), a RAM (random-access memory) that deploys the program above, and the like. Moreover, an object of the disclosure is achieved by the computer (or the CPU) reading and executing the program above from the recording medium. As the recording medium, a “non-temporary, tangible medium” such as a tape, a disk, a card, a semiconductor memory, or a programmable logic circuit can be used. Moreover, the program may be supplied to the computer via any transmission medium that can transmit the program (such as a communication network or a broadcast wave). Note that one aspect of the disclosure can also be realized in the form of a data signal embedded in a carrier wave, where the program is embodied as an electronic transmission.

### Supplement

An image forming device (copiers 1A to 1I) according to aspect 1 of the disclosure is an image forming device that forms an image on a recording material (sheet of paper P), provided with: a first illuminator (first illuminator 21, second illuminator 22, third illuminator 23, fourth illuminator 24) and a second illuminator (first illuminator 21, second illuminator 22) that irradiate a light to the recording material; a transmitted-light photodetector (first photodetector 31, second photodetector 32, third photodetector 33, fourth photodetector 34) that receives a portion of a light that is irradiated from the first illuminator and transmitted through the recording material; a reflected-light photodetector (first photodetector 31, second photodetector 32) that receives a portion of a light that is irradiated from the second illuminator and reflected or diffused by the recording material; a calculator (paper-type determination processors 62A to 62E, moisture-content calculators 63A to 63E, basis-weight calculators 64A to 64E) that calculates or determines at least one from among a moisture content, a type, and a basis weight of the recording material based on intensities of the lights received by the transmitted-light photodetector and the reflected-light photodetector; and a configuration processor age forming conditions configuration processor 65) that configures image forming conditions of the image on the recording material based on a calculation or determination result of the calculator.

According to the configuration above, the type of the recording material, a moisture content of a surface of the recording material, and the basis weight of the recording material can be determined and calculated based on the intensity of the light reflected or diffused by the recording material and the intensity of the light transmitted through the recording material. As a result, the type of the recording material, the moisture content of the surface of the recording material, and the basis weight of the recording material can be determined and calculated by considering various information on the recording material (such as a state of water molecules of the surface, information on water molecules inside, and a thickness). As a result, the type of the recording material, the moisture content of the surface of the recording material, and the basis weight of the recording material can be precisely calculated and determined. Therefore, appropriate image forming conditions can be configured.

An image forming device (copiers ID to 1H) according to aspect 2 of the disclosure may be of a configuration where in aspect 1 the transmitted-light photodetector is provided with a first transmitted-light photodetector (first photodetector 31, second photodetector 32, third photodetector 33) and a second transmitted-light photodetector (second photodetector 32, third photodetector 33, fourth photodetector 34) and the first transmitted-light photodetector and the second transmitted-light photodetector receive a portion of the light transmitted through the recording material at different angles.

Here, a light transmitted through the recording material at a non-perpendicular angle is affected differently than a light transmitted through the recording material perpendicularly due to a state of components cellulose of the recording material. Therefore, according to the configuration above, information on the state of the components and the cellulose of the recording material can be more accurately acquired. As a result, the type of the recording material, the moisture content of the surface of the recording material, and the basis weight of the recording material can be respectively more precisely determined and calculated.

An image forming device (copiers 1C, 1E to 1H) according to aspect 3 of the disclosure may be of a configuration where in aspect 1 or 2 the reflected-light photodetector is provided with a first reflected-light photodetector (first photodetector 31) and a second reflected-light photodetector (second photodetector 32) and the first reflected-light photodetector and the second reflected-light photodetector receive a portion of the light reflected or diffused by the recording material at different angles.

According to the configuration above, information on a state of adhesion of water molecules on the surface of the recording material and information on a state of the water molecules inside the recording material can be more accurately acquired. As a result, the type of the recording material, the moisture content of the surface of the recording material, and the basis weight of the recording material can be respectively more precisely determined and calculated. In particular, because the light reflected by the recording material includes the information on the state of adhesion of the water molecules on the surface of the recording material, a calculation precision of the moisture content of the surface of the recording material can be improved.

An image forming device (copiers 1G, 1H) according to aspect 4 of the disclosure may be of a configuration where in any one of aspects 1 to 3 further provided is a third illuminator (second illuminator 22, fourth illuminator 24) that irradiates a light of a wavelength different from a wavelength of the light irradiated by the first illuminator (first illuminator 21, third illuminator 23), wherein the transmitted-light photodetector receives portions of lights that are irradiated from the first illuminator and the third illuminator and transmitted through the recording material.

According to the configuration above, more information on the state of the components and the cellulose fibers of the recording material can be acquired. As a result, determination of the paper type of the recording material, calculation of the moisture content of the surface of the recording material, and calculation of the basis weight of the recording material can be precisely performed.

An image forming device (copiers 1G, 1H) according to aspect 5 of the disclosure may be of a configuration where in any one of aspects 1 to 3 further provided is a fourth illuminator (second illuminator 22, fourth illuminator 24) that irradiates a light of a wavelength different from a wavelength of the light irradiated by the second illuminator (first illuminator 21, third illuminator 23), wherein the reflected-light photodetector receives portions of lights that are irradiated from the second illuminator and the fourth illuminator and reflected or diffused by the recording material.

According to the configuration above, more information on the state of the water molecules of the surface and the state of the cellulose fibers of the recording material can be acquired. As a result, determination of the paper type of the recording material, calculation of the moisture content of the surface of the recording material, and calculation of the basis weight of the recording material can be precisely performed.

An image forming device (copiers 1A, 1C to 1E, 1H) according to aspect 6 of the disclosure may be of a configuration where in any one of aspects 1 to 5 the first illuminator and the second illuminator are the same illuminator.

According to the configuration above, because the first illuminator and the second illuminator can be made to be one illuminator, the configuration of the image forming device can be simplified.

An image forming device (copiers 1B, 1F, 1G) according to aspect 7 of the disclosure may be of a configuration where in any one of aspects 1 to 6 the transmitted-light photodetector and the reflected-light photodetector are the same photodetector.

According to the configuration above, because the transmitted-light photodetector and the reflected-light photodetector can be made to be one photodetector, the configuration of the image forming device can be simplified.

An image forming device (copiers 1A to 1H) according to aspect 8 of the disclosure may be of a configuration where in any one of aspects 1 to 7 further provided are a paper ted cassette that contains the recording material, an extraction roller (pickup roller 4) that extracts the recording material from the paper feed cassette, and a retention roller (idle roller 5) that temporarily retains the recording material on a conveyance route before transfer processing is performed on the recording material, wherein the first illuminator and the second illuminator irradiate the light to the recording material that is extracted from the paper feed cassette and temporarily retained by the retention roller.

According to the configuration above, because the configuration is of measuring the recording material temporarily retained by the retention roller, time required for image formation can be shortened.

An image forming device (copier 1I) according to aspect 9 of the disclosure may be of a configuration where in any one of aspects 1 to 7 further provided are a paper feed cassette that contains the recording material and an extraction roller (pickup roller 4) that extracts the recording material from the paper feed cassette, wherein the first illuminator and the second illuminator irradiate the light to the recording material that is extracted from the paper feed cassette by the extraction roller and being conveyed by the extraction roller.

According to the configuration above, because configuration of the image forming conditions by the configuration processor can be quickly performed, time required for printing can be shortened.

An image forming device (copiers 1A to 1I) according to aspect 10 of the disclosure may be of a configuration where in any one of aspects 1 to 9 the first illuminator and the second illuminator irradiate the light to at least two locations that are a central portion and an end portion of the recording material.

According to the configuration above, an influence of a characteristic (such as moisture content, thickness) of the central portion and the end portion of the recording material can be suppressed.

The image forming device (copiers 1A to 1I) according to aspect 11 of the disclosure may be of a configuration where in any one of aspects 1 to 10 the wavelengths of the lights emitted by the first illuminator and the second illuminator are from 800 nm to 1100 nm.

According to the configuration above, the lights irradiated by the first illuminator and the second illuminator can penetrate inside the recording material and are readily absorbed by moisture. By this, more information on moisture included in the recording material can be obtained.

An image forming device (copiers 1A to 1I) according to aspect 12 of the disclosure may be of a configuration where in any one of aspects 1 to 11 further provided are an image-carrying body (photoreceptor drum 11) that carries a developed image (toner image) obtained by developing an electrostatic latent image based on image data by a developing agent (toner agent); a transfer device (transfer device 15) that performs transfer processing, which is transferring the developed image carried by the image-carrying body to the recording material; and a fuser (16) that fixes the developing agent transferred by the transfer device to the recording material; wherein the image forming conditions are at least one configuration value from among a voltage value applied to the transfer device, a current value supplied to the transfer device, a pressure imparted to the recording material in the fuser, a temperature whereby the recording material is heated in the fuser, and a speed whereat the recording material is conveyed in the fuser.

An image forming method according to aspect 13 of the disclosure is an image forming method of forming an image on a recording material (sheet of paper P), provided with a first measurement step of measuring an intensity of a light that is irradiated from a first illuminator (first illuminator 21, second illuminator 22, third illuminator 23, fourth illuminator 24) and transmitted through the recording material, a second measurement step of measuring an intensity of a light that is irradiated from a second illuminator (first illuminator 21, second illuminator 22) and reflected or diffused by the recording material, a calculation step of calculating or determining at least one from among a moisture content, a type, and a basis weight of the recording material based on the intensities of the lights measured at the first measurement step and the second measurement step, and a configuration step of configuring image forming conditions of the image on the recording material based on a calculation or determination result at the calculation step.

According to the configurations above, effects similar to those of aspect 1 can be obtained.

The disclosure is not limited to the embodiments described above and can be variously modified within the scope indicated by the claims; embodiments obtained by suitably combining technical means disclosed in different embodiments are also included in the technical scope of the disclosure. Moreover, new technical features can be formed by combining technical means disclosed in the embodiments.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An image forming device configured to form an image on a recording material, comprising:
a first illuminator and a second illuminator configured to irradiate a light to the recording material;
a transmitted-light photodetector configured to receive a portion of a light irradiated from the first illuminator and transmitted through the recording material;
a reflected-light photodetector configured to receive a portion of a light irradiated from the second illuminator and reflected or diffused by the recording material;
a calculator configured to calculate or determine at least one from among a moisture content, a type, and a basis weight of the recording material based on intensities of the lights received by the transmitted-light photodetector and the reflected-light photodetector; and
a configuration processor configured to configure image forming conditions of the image on the recording material based on a calculation or determination result of the calculator.

2. The image forming device according to claim 1,
wherein the transmitted-light photodetector is provided with a first transmitted-light photodetector and a second transmitted-light photodetector, and
the first transmitted-light photodetector and the second transmitted-light photodetector receive a portion of the light transmitted through the recording material at different angles.

3. The image forming device according to claim 1,
wherein the reflected-light photodetector is provided with a first reflected-light photodetector and a second reflected-light photodetector, and
the first reflected-light photodetector and the second reflected-light photodetector receive a portion of the light reflected or diffused by the recording material at different angles.

4. The image forming device according to claim 1, further comprising:
a third illuminator configured to irradiate a light of a wavelength different from a wavelength of the light irradiated by the first illuminator; wherein
the transmitted-light photodetector receives portions of lights irradiated from the first illuminator and the third illuminator and transmitted through the recording material.

5. The image forming device according to claim 1, further comprising:
a fourth illuminator configured to irradiate a light of a wavelength different from a wavelength of the light irradiated by the second illuminator; wherein
the reflected-light photodetector receives portions of lights irradiated from the second illuminator and the fourth illuminator and reflected or diffused by the recording material.

6. The image forming device according to claim 1, wherein the first illuminator and the second illuminator are the same illuminator.

7. The image forming device according to claim 1, wherein the transmitted-light photodetector and the reflected-light photodetector are the same photodetector.

8. The image forming device according to claim 1, further comprising:
a paper feed cassette that contains the recording material;
an extraction roller configured to extract the recording material from the paper feed cassette; and
a retention roller configured to temporarily retain the recording material on a conveyance route before transfer processing is performed on the recording material;
wherein
the first illuminator and the second illuminator irradiate the light to the recording material extracted from the paper ted cassette by the extraction roller and temporarily retained by the retention roller.

9. The image forming device according to claim 1, further comprising:
a paper feed cassette that contains the recording material; and
an extraction roller configured to extract the recording material from the paper feed cassette; wherein
the first illuminator and the second illuminator irradiate the light to the recording material extracted from the paper feed cassette by the extraction roller and being conveyed by the extraction roller.

10. The image forming device according to claim 1, wherein the first illuminator and the second illuminator irradiate the light to at least two locations that are a central portion and an end portion of the recording material.

11. The image forming device according to claim 1, wherein the wavelengths of the lights emitted by first illuminator and the second illuminator are from 800 nm to 1100 nm.

12. The image forming device according to claim 1, further comprising:
an image-carrying body configured to carry a developed image obtained by developing an electrostatic latent image based on image data by a developing agent;
a transfer device configured to perform transfer processing, which is transferring the developed image carried by the image-carrying body to the recording material; and
a fuser configured to fix the developing agent transferred by the transfer device to the recording material; wherein
the image forming conditions are at least one configuration value from among a voltage value applied to the transfer device, a current value supplied to the transfer device, a pressure imparted to the recording material in the fuser, a temperature whereby the recording material is heated in the fuser, and a speed whereat the recording material is conveyed in the fuser.

13. An image forming method of forming an image on a recording material, comprising:
measuring an intensity of a light irradiated from a first illuminator and transmitted through the recording material;
measuring an intensity of a light irradiated from a second illuminator and reflected or diffused by the recording material;
calculating or determining at least one from among a moisture content, a type, and a basis weight of the recording material based on the intensities of the lights measured at the first measurement step and the second measurement step; and
configuring image forming conditions of the image on the recording material based on a calculation or determination result at the calculation step.
